(19) United States
(12) Patent Application Publication
(10) Pub. No.: US 2017/0078178 A1
(43) Pub. Date: Mar. 16, 2017

(54) DELAY INFORMATION OUTPUT DEVICE, DELAY INFORMATION OUTPUT METHOD, AND NON-TRANSITORY COMPUTER-READABLE RECORDING MEDIUM

(71) Applicant: FUJITSU LIMITED, Kawasaki-shi (JP)

(72) Inventor: Yasuhiko Kanemasa, Kawasaki (JP)

(73) Assignee: FUJITSU LIMITED, Kawasaki-shi (JP)

(21) Appl. No.: 15/239,854

(22) Filed: Aug. 18, 2016

(30) Foreign Application Priority Data
Sep. 16, 2015 (JP) 2015-183465

(51) Int. Cl. H04L 12/26; H04L 12/24; H04L 29/08

(52) U.S. Cl. CPC H04L 43/0852; H04L 67/02; H04L 67/10; H04L 67/325; H04L 43/04; H04L 43/067; H04L 43/16; H04L 41/0631

(57) ABSTRACT

A delay information output device calculates a first partial correlation coefficient by removing an effect of both the number of calls, per time, of all of requests and the number of delays, per time, of all of requests with a response time that exceeds an allowed time from a correlation coefficient between a first request and a second request. The delay information output device calculates a second partial correlation coefficient by removing an effect of requests that are other than the first request and the second request from the first partial correlation coefficient. The delay information output device determines a set of requests that have the cause-and-effect relationship of a delay on the basis of the second partial correlation coefficient.

### CROSS-REFERENCE TO RELATED APPLICATION(S)

This application is based upon and claims the benefit of priority of the prior Japanese Patent Application No. 2015-183465, filed on Sep. 16, 2015, the entire contents of which are incorporated herein by reference.

### FIELD

The embodiment discussed herein is related to a delay information output device and the like.

### BACKGROUND

There is a multi-tier system, on the Internet, that responds to requests from user terminals and that provides various kinds of services. The multi-tier system is constructed from a plurality of tiers, such as a Web tier, an application (AP) tier, a database (DB) tier, or the like; Web servers are present in the Web tier; AP servers are present in the AP tier; and DB servers are present in the DB tier. In a description below, a Web server, an AP server, and a DB server are collectively and appropriately be referred to as a server.

When a Web server receives a request from a user terminal, the Web server performs a process in accordance with the request type. Furthermore, the Web server issues, in the course of the process, a request to an AP server in the AP tier that is a lower level. In also the AP server, the AP server performs a process in accordance with the request type issued by the Web server and issues, in the course of the process, a request to a DB server in the DB tier that is a lower level. Sending requests between the servers is sometimes repeated more than once.

Here, there is a monitoring system that monitors the response time when a request is issued to a server. The monitoring system models each of the normal response time regarding many request types in a server. The monitoring system monitors the response time of each of the request types on the basis of the model and issues an alert if the monitored response time exceeds an upper threshold that is determined by the model.

Patent Document 1: Japanese Laid-open Patent Publication No. 2008-3819

Patent Document 2: International Publication Pamphlet No. WO 2010/032701

Patent Document 3: Japanese Laid-open Patent Publication No. 2011-258057

Patent Document 4: Japanese Laid-open Patent Publication No. 2008-84039

Patent Document 5: Japanese Laid-open Patent Publication No. 2014-123198

However, with the conventional technology described above, there is a problem in that it is not able to determine the request type that is the cause of a delay.

FIGS. 38 and 39 are schematic diagrams each illustrating a problem of a conventional technology. In a specific request type, if a process delay occurs, the effect of the request type of the generated delay causes a process delay of another request type and many request types are simultaneously delayed. For example, in the example illustrated in FIG. 38, if a delay occurs in a request X, a delay occurs, due to the effect of this delay, in each of the requests A, B, C, D, Y, and Z. In the conventional technology, because the call relationship among the requests is not able to be accurately determined, it is difficult to determine which request type originally causes the delay.

Furthermore, similarly, in a case in which a call of a specific request type causes a delay of another request type, it is also difficult to identify the request type that causes the delay. For example, as illustrated in FIG. 39, when the request X calls the request A, if a delay occurs in the request X, it may possibly be erroneously determined that a delay occurs in the request A and the request A affects the delay.

Accordingly, it is an object in one aspect of an embodiment of the present invention to provide a delay information output device, a delay information output method, and a delay information output program that can determine the request type that causes a delay.

According to an aspect of an embodiment, a delay information output device includes a first partial correlation coefficient calculating unit, a second partial correlation coefficient calculating unit, and a determination unit. The first partial correlation coefficient calculating unit calculates, on the basis of first information and second information, a first partial correlation coefficient by removing both the relationship between the number of calls and the time of all of the requests and the relationship between the number of delays and the time of all of the requests with response time that exceeds the allowed time from correlation coefficients of a first request and a second request. The second partial correlation coefficient calculating unit calculates a second partial correlation coefficient by removing the effect of the requests that are other than the first request and the second request from the first partial correlation coefficient. The determination unit determines, on the basis of the second partial correlation coefficient, a set of requests that has the call relationship.

### SUMMARY

According to an aspect of an embodiment, a delay information output device includes: a processor that executes a process including: calculating a first partial correlation coefficient by removing an effect of both the number of calls, per time, of all of requests and the number of delays, per time, of all of requests with a response time that exceeds an allowed time from a correlation coefficient between a first request and a second request on the basis of first information that indicates, per time, the number of calls of a request for each type between predetermined devices and on the basis of second information that indicates, per time, the number of delays of a request for each type with the response time that exceeds the allowed time that is allowed as the time needed for a response when the request is called; calculating a second partial correlation coefficient by removing an effect of requests that are other than the first request and the second request from the first partial correlation coefficient; and determining a set of requests that have the cause-and-effect relationship of a delay on the basis of the second partial correlation coefficient.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating the configuration of a system according to an embodiment;

FIG. 2 is a functional block diagram illustrating the configuration of a delay information output device according to the embodiment;

FIG. 3 is a schematic diagram illustrating an example of the data structure of aggregated data;

FIG. 4 is a schematic diagram illustrating an example of the data structure of response delay data;

FIG. 5 is a schematic diagram illustrating an example of the data structure of a correlation coefficient table;

FIG. 6 is a schematic diagram illustrating an example of the data structure of a first partial correlation coefficient table;

FIG. 7 is a schematic diagram illustrating an example of the data structure of a second partial correlation coefficient table;

FIG. 8 is a schematic diagram (1) illustrating an example of a process that removes the effect of the overall trend;

FIG. 9 is a schematic diagram (2) illustrating an example of a process that removes the effect of the overall trend;

FIG. 10 is a schematic diagram (3) illustrating an example of a process that removes the effect of the overall trend;

FIG. 11 is a schematic diagram (4) illustrating an example of a process that removes the effect of the overall trend;

FIG. 12 is a schematic diagram (5) illustrating an example of a process that removes the effect of the overall trend;

FIG. 13 is a schematic diagram (1) illustrating an example of a process that comprehensively removes the reciprocal effects between the request types by using partial correlation analysis;

FIG. 14 is a schematic diagram (2) illustrating an example of a process that comprehensively removes the reciprocal effects between the request types by using the partial correlation analysis;

FIG. 15 is a schematic diagram (3) illustrating an example of a process that comprehensively removes the reciprocal effects between the request types by using the partial correlation analysis;

FIG. 16 is a schematic diagram (4) illustrating an example of a process that comprehensively removes the reciprocal effects between the request types by using the partial correlation analysis;

FIG. 17 is a schematic diagram (5) illustrating an example of a process that comprehensively removes the reciprocal effects between the request types by using the partial correlation analysis;

FIG. 18 is a schematic diagram (6) illustrating an example of a process that comprehensively removes the reciprocal effects between the request types by using the partial correlation analysis;

FIG. 19 is a schematic diagram (7) illustrating an example of a process that comprehensively removes the reciprocal effects between the request types in a partial correlation analysis;

FIG. 20 is a schematic diagram (8) illustrating an example of a process that comprehensively removes the reciprocal effects between the request types by using the partial correlation analysis;

FIG. 21 is a schematic diagram (9) illustrating an example of a process that comprehensively removes the reciprocal effects between the request types by using the partial correlation analysis;

FIG. 22 is a schematic diagram (10) illustrating an example of a process that comprehensively removes the reciprocal effects between the request types by using the partial correlation analysis;

FIG. 23 is a schematic diagram (11) illustrating an example of a process that comprehensively removes the reciprocal effects between the request types by using the partial correlation analysis;

FIG. 24 is a schematic diagram (12) illustrating an example of a process that comprehensively removes the reciprocal effects between the request types by using the partial correlation analysis;

FIG. 25 is a schematic diagram (13) illustrating an example of a process that comprehensively removes the reciprocal effects between the request types by using the partial correlation analysis;

FIG. 26 is a schematic diagram (14) illustrating an example of a process that comprehensively removes the reciprocal effects between the request types by using the partial correlation analysis;

FIG. 27 is a schematic diagram (15) illustrating an example of a process that comprehensively removes the reciprocal effects between the request types by using the partial correlation analysis;

FIG. 28 is a schematic diagram (16) illustrating an example of a process that comprehensively removes the reciprocal effects between the request types by using the partial correlation analysis;

FIG. 29 is a schematic diagram (1) illustrating an example of a visualized determination result;

FIG. 30 is a schematic diagram (2) illustrating an example of a visualized determination result;

FIG. 31 is a schematic diagram illustrating an example of a ranking list created by a determination unit;

FIG. 32 is a flowchart illustrating the flow of a process performed by the delay information output device according to the embodiment;

FIG. 33 is a flowchart (1) illustrating the flow of an analytical process of the delay correlation;

FIG. 34 is a flowchart (2) illustrating the flow of an analytical process of the delay correlation;

FIG. 35 is a flowchart (3) illustrating the flow of an analytical process of the delay correlation;

FIG. 36 is a flowchart illustrating the flow of a process that comprehensively removes the reciprocal effects between the request types by using the partial correlation analysis;

FIG. 37 is a block diagram illustrating an example of a computer that executes a delay information output program;

FIG. 38 is a schematic diagram (1) illustrating a problem of a conventional technology; and

FIG. 39 is a schematic diagram (2) illustrating a problem of a conventional technology.

### DESCRIPTION OF EMBODIMENT

Preferred embodiments of the present invention will be explained with reference to accompanying drawings. Furthermore, the present invention is not limited to the embodiment.

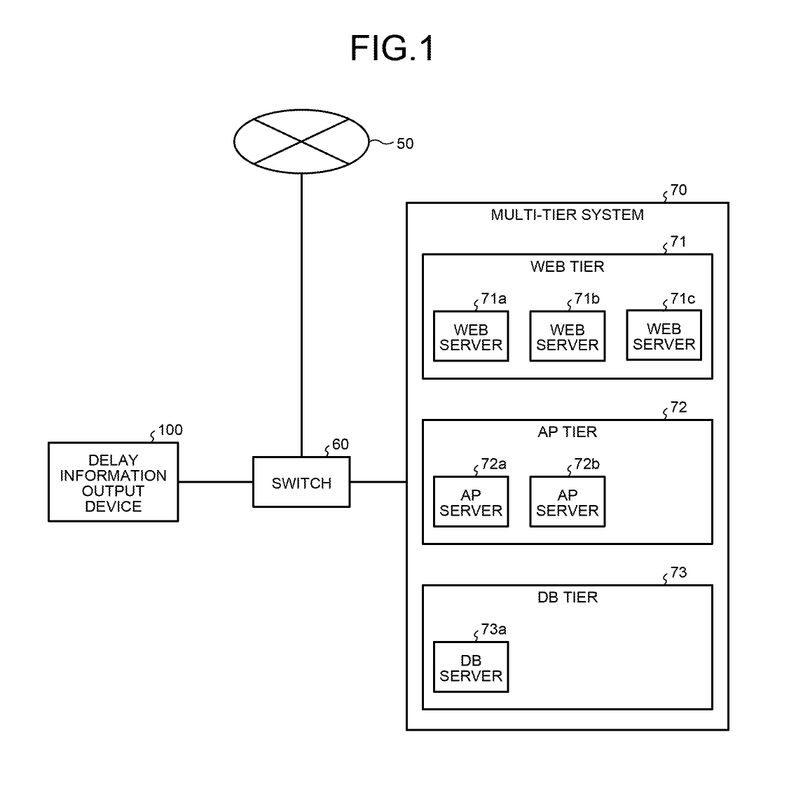

FIG. 1 is a schematic diagram illustrating the configuration of a system according to an embodiment. As illustrated in FIG. 1, this system includes a switch 60, a multi-tier system 70, and a delay information output device 100. The multi-tier system 70 and the delay information output device 100 are connected to the switch 60. The switch 60 is connected to a network 50.

The switch 60 is a device that relays data communication between the multi-tier system 70 and the network 50. Furthermore, when the switch 60 receives packet information from the multi-tier system 70, the switch 60 sends the packet information to the delay information output device 100. The packet information will be described later.

The multi-tier system 70 is a system that provides a service by servers in the tiers cooperating with each other. For example, the multi-tier system 70 includes a Web tier 71, an AP tier 72, and a DB tier 73. The Web tier 71 is a tier that includes servers each of which provides a service in accordance with a request from client software, such as a Web browser or the like and that includes Web servers 71a, 71b, and 71c. The Web tier 71 may also include another server.

The AP tier 72 is a tier that includes servers each of which has a function of concatenating execution environment of programs or concatenating the Web tier 71 and the DB tier 73 and that includes AP servers 72a and 72b. The AP tier 72 may also include another server. The DB tier 73 is a tier that includes a server, which sends data requested from the server in the Web tier 71 or the AP tier 72 and rewrites data in response to an operation request, and that includes a DB server 73a. The DB tier 73 may also include another server.

Furthermore, the multi-tier system 70 sends, in accordance with a request from the delay information output device 100, the packet information to the delay information output device 100. The packet information includes information on packets that are sent and received between the servers in the respective tiers in the multi-tier system 70.

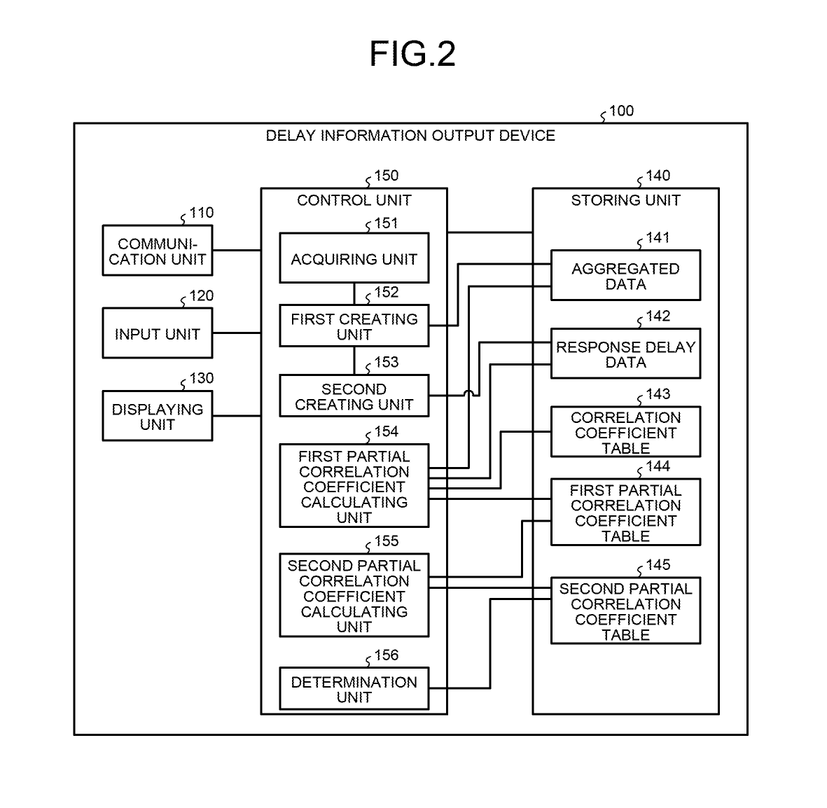

The delay information output device 100 is a device that determines the request type that causes a delay in the multi-tier system 70. FIG. 2 is a functional block diagram illustrating the configuration of a delay information output device according to the embodiment. As illustrated in FIG. 2, the delay information output device 100 includes a communication unit 110, an input unit 120, a displaying unit 130, a storing unit 140, and a control unit 150.

The communication unit 110 is a processing unit that performs data communication with another device via the switch 60 and the network 50. For example, the communication unit 110 corresponds to a communication device. The control unit 150, which will be described later, sends and receives data to and from another device via the communication unit 110.

The input unit 120 is an input device that is used to input various kinds of information to the delay information output device 100. For example, the input unit 120 corresponds to a keyboard, a mouse, a touch panel, an input button, or the like. The displaying unit 130 is a display device that displays information that is output from the control unit 150. The displaying unit 130 corresponds to a liquid crystal display, a touch panel, or the like.

The storing unit 140 includes aggregated data 141, response delay data 142, a correlation coefficient table 143, a first partial correlation coefficient table 144, and a second partial correlation coefficient table 145. The storing unit 140 corresponds to a storage device, such as a semiconductor memory device including, for example, a random access memory (RAM), a read only memory (ROM), a flash memory, or the like.

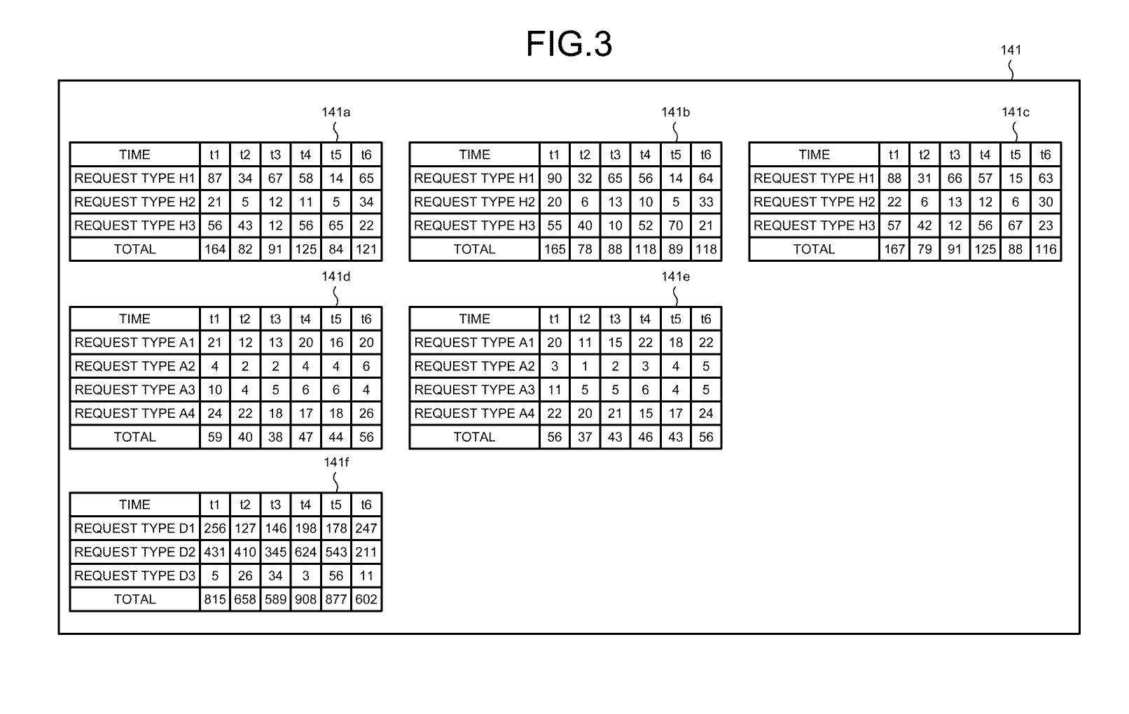

FIG. 3 is a schematic diagram illustrating an example of the data structure of aggregated data. As illustrated in FIG. 3, the aggregated data 141 includes a plurality of pieces of individual aggregated data 141a to 141f associated with each of the servers. The individual aggregated data 141a is aggregated data that is related to the request called by the Web server 71a. The individual aggregated data 141b is aggregated data that is related to the request called by the Web server 71b. The individual aggregated data 141c is aggregated data that is related to the request called by the Web server 71c.

The individual aggregated data 141d is aggregated data that is related to the request called by the AP server 72a. The individual aggregated data 141e is aggregated data that is related to the request called by the AP server 72b. The individual aggregated data 141f is aggregated data that is related to the request called by the DB server 73a.

The individual aggregated data 141a associates the time with the number of calls of a request that is associated with the request type. For example, regarding the request with a request type H1, the number of calls at time t1 is “87”. Regarding the request with the request type H1, the number of each of the calls at time t2, t3, t4, t5, t6 are 34, 67, 58, 14, and 65, respectively. Descriptions related to the request types H2 and H3 will be omitted.

Furthermore, in the individual aggregated data 141a, the total number of calls of each of the requests at the time t1, t2, t3, t4, t5, and t6 are 164, 82, 91, 125, 84, and 121, respectively.

Descriptions related to the individual aggregated data 141b to 141f are the same as that related to the individual aggregated data 141a; therefore, descriptions thereof will be omitted.

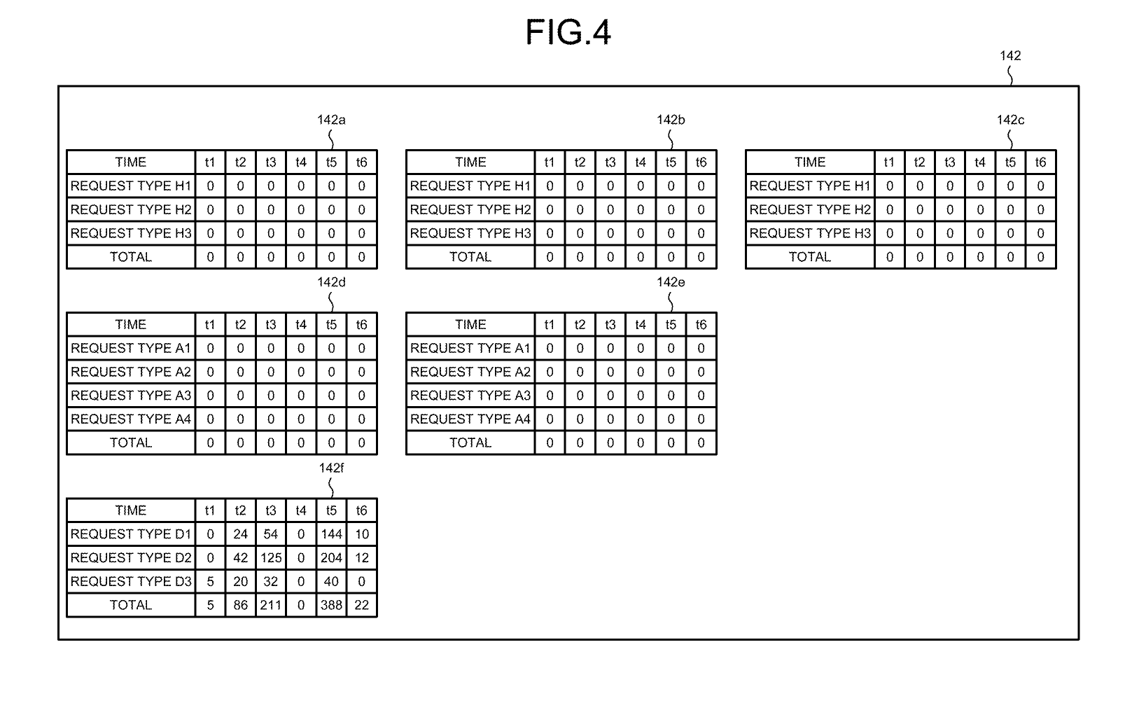

FIG. 4 is a schematic diagram illustrating an example of the data structure of response delay data. As illustrated in FIG. 4, this response delay data includes a plurality of pieces of individual response delay data 142a to 142f associated with each of the servers. The individual response delay data 142a is information that is related to the request in which a delay occurs from among the requests called by the Web server 71a. The individual response delay data 142b is information that is related to the request in which a delay occurs from among the requests called by the Web server 71b. The individual response delay data 142c is information that is related to the request in which a delay occurs from among the requests called by the Web server 71c.

The individual response delay data 142d is information that is related to the request in which a delay occurs from among the requests called by the AP server 72a. The individual response delay data 142e is information that is related to the request in which a delay occurs from among the requests called by the AP server 72b. The individual response delay data 142f is information that is related to the request in which a delay occurs from among the requests called by the DB server 73a.

The individual response delay data 142a associates the time with the number of delays of a request that is associated with the request type. In the example illustrated in FIG. 4, because no delay occurs in the request called by the Web server 71a, the number of delays at each time is represented by “0”. The same also applies to the individual response delay data 142b to 142e.

The individual response delay data 142f associates the time with the number of delays of a request that is associated with the request type. For example, regarding to the request with a request type D1, the number of delays at the time t1 is “0”. Regarding the request with a request type D1, the number of delays at the time t2, t3, t4, t5, and t6 are 24, 54, 0, 144, and 10, respectively.

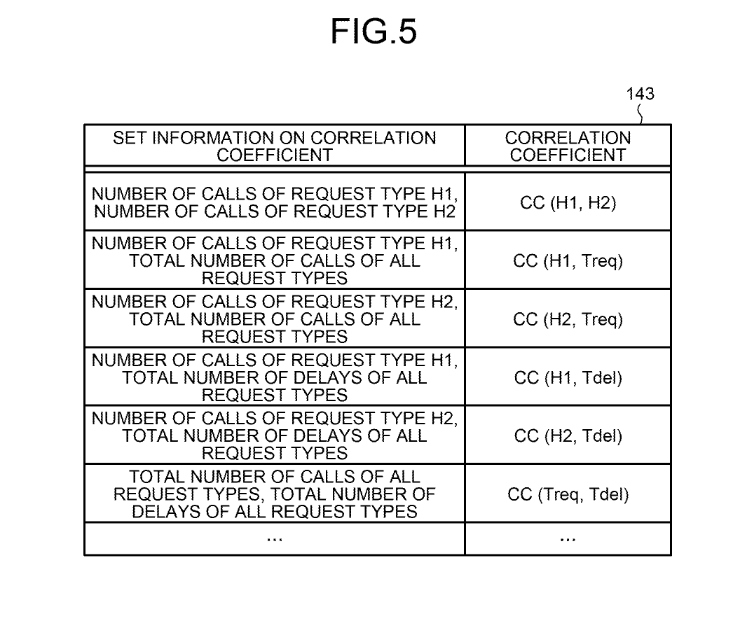

FIG. 5 is a schematic diagram illustrating an example of the data structure of a correlation coefficient table. As illustrated in FIG. 5, the correlation coefficient table associates the set information on the correlation coefficient with the correlation coefficient. The set information on the correlation coefficient is information indicating a set of request types in each of which the correlation coefficient has been calculated. For example, the set information on the correlation coefficient includes a set of the number of calls of a certain request type and the number of calls of another request type. The set information on the correlation coefficient includes a set of the number of calls of a certain request type and the total number of calls of all of the request types. The set information on the correlation coefficient includes a set of the number of calls of a certain request type and the total number of delays of all of the request types. Although not illustrated in the drawing, the set information on the correlation coefficient includes a set of the number of delays of a certain request type and the total number of calls of all of the request types. The set information on the correlation coefficient includes a set of the number of delays of a certain request type and the total number of delays of all of the request types. The set information on the correlation coefficient includes a set of the number of calls of a certain request type and the number of delays of another request. The set information on the correlation coefficient includes a set of the number of delays of a certain request type and the number of delays of another request.

Here, the total number of calls of all of the request types corresponds to, for example, the sum total of the number of calls, per time, in the individual aggregated data 141a to 141f illustrated in FIG. 3. The total number of delays of all of the request types corresponds to the sum total of the number of delays, per time, in the individual response delay data 142a to 142f illustrated in FIG. 4.

The record in the first line illustrated in FIG. 5 indicates that the correlation coefficient between the “number of calls with the request type H1” and the “number of calls with the request type H2” is “CC (H1, H2)”. The record in the second line illustrated in FIG. 5 indicates that the correlation coefficient between the “number of calls with the request type H1” and the “total number of calls of all of the request types” is “CC (H1, T_{req})”.

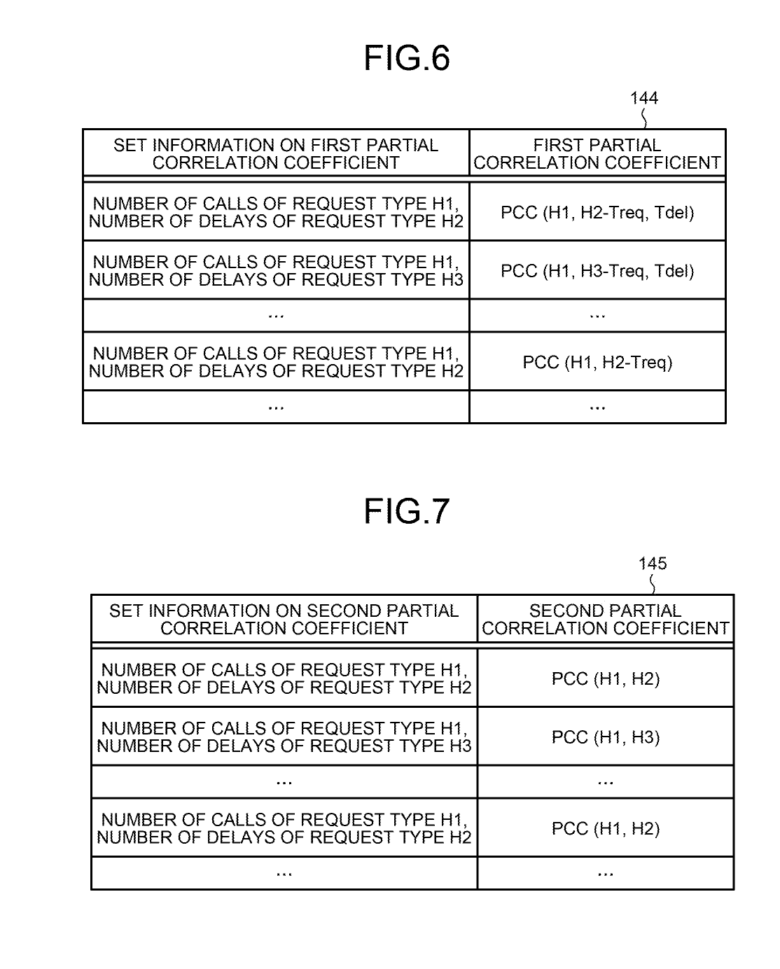

FIG. 6 is a schematic diagram illustrating an example of the data structure of a first partial correlation coefficient table. As illustrated in FIG. 6, the first partial correlation coefficient table 144 associates the set information on the first partial correlation coefficient with the first partial correlation coefficient. The set information on the first partial correlation coefficient is information that indicates a set of the request types in which the first partial correlation coefficient is calculated. The first partial correlation coefficient is a partial correlation coefficient that is obtained by removing the effect of the overall trend from the correlation coefficient. The record in the first line illustrated in FIG. 6 indicates that the first partial correlation coefficient between the “number of calls with the request type H1” and the “number of delays with the request type H2” is “PCC (H1, H2-T_{req}, T_{del})”.

FIG. 7 is a schematic diagram illustrating an example of the data structure of a second partial correlation coefficient table. As illustrated in FIG. 7, the second partial correlation coefficient table 145 associates the set information on the second partial correlation coefficient with the second partial correlation coefficient. The set information on the second partial correlation coefficient is information indicating a set of request types in which the second partial correlation coefficient is calculated. The second partial correlation coefficient is a partial correlation coefficient that is obtained by removing the reciprocal effect of another request type from the first partial correlation coefficient. The record in the first line illustrated in FIG. 7 indicates that the second partial correlation coefficient between the “number of calls with the request type H1” and the “number of delays with the request type H2” is “PCC (H1, H2)”.

A description will be given here by referring back to FIG. 2. The control unit 150 includes an acquiring unit 151, a first creating unit 152, a second creating unit 153, a first partial correlation coefficient calculating unit 154, a second partial correlation coefficient calculating unit 155, and a determination unit 156. The control unit 150 corresponds to, for example, an integrated circuit, such as an application specific integrated circuit (ASIC), a field programmable gate array (FPGA), or the like. Furthermore, the control unit 150 corresponds to an electronic circuit, such as a central processing unit (CPU), a micro processing unit (MPU), or the like.

The acquiring unit 151 is a processing unit that requests packet information with respect to the multi-tier system 70 and that acquires the packet information from the multi-tier system 70. The acquiring unit 151 outputs the acquired packet information to the first creating unit 152.

The first creating unit 152 is a processing unit that creates, on the basis of the packet information, the aggregated data 141 illustrated in FIG. 3. The first creating unit 152 may also create the aggregated data 141 from the packet information on the basis of any technology. For example, the first creating unit 152 analyzes a protocol of a packet included in the packet information, calculates the relationship between the number of calls and the time for each of the request types, and creates the aggregated data 141. The first creating unit 152 stores the aggregated data 141 in the storing unit 140.

Furthermore, the first creating unit 152 analyzes the packet information and creates response time information. For example, the response time information is information that indicates the relationship between a request and the response time of the request. The first creating unit 152 outputs the response time information to the second creating unit 153.

The second creating unit 153 is the processing unit that creates, on the basis of the response time information, the response delay data 142 illustrated in FIG. 4. The second creating unit 153 may also create the response delay data 142 by using any technology. For example, the second creating unit 153 holds information on the allowed time that is allowed as the time needed to respond to a request for each request. The second creating unit 153 compares the response time information with the allowed time and creates the response delay data 142 by counting, per time, regarding to each of the requests with the sets of the request types, the number of requests having the response time that exceeds the allowed time.

The first partial correlation coefficient calculating unit 154 is a processing unit that calculates a correlation coefficient between each of the sets of the request types on the basis of the aggregated data 141 and the response delay data 142. Furthermore, by removing the effect of the overall trend in the multi tiers from the correlation coefficient between each of the sets of the request types, the first partial correlation coefficient calculating unit 154 calculates the first partial correlation coefficient between each of the sets of the request types.

In the following a process performed by the first partial correlation coefficient calculating unit 154 will specifically be described. First, regarding the time series data of the number of calls for each request type and the time series data of the number of delays, the first partial correlation coefficient calculating unit 154 calculates the correlation coefficient in a round robin set. The time series data of the number of calls for each request type is data that indicates the relationship between the time and the number of calls. The time series data of the number of delays is data that indicates the relationship between the time and the number of delays.

The time series data of the number of calls and the time series data of the number of delays have values the number of which is k in accordance with the aggregate granularity and the aggregate time. For example, if data is aggregated per minute, an amount of data accumulated in a single day corresponds to the vector with the value of 60×24=1440.

For example, if a delay is observed in n request types out of m request types, each of the correlation coefficients related to (m+n)×(m+n−1) sets is calculated. The first partial correlation coefficient calculating unit 154 calculates each of the correlation coefficients in response to an input of both the time series data. The first partial correlation coefficient calculating unit 154 stores each of the calculation results of the correlation coefficients in the correlation coefficient table 143.

Furthermore, the first partial correlation coefficient calculating unit 154 calculates the correlation coefficient between the time series data of the number of calls of each of the request types and the time series data of the total number of calls of all of the request types and stores the calculation result in the correlation coefficient table 143. The first partial correlation coefficient calculating unit 154 calculates the correlation coefficient between the time series data of the number of calls of each of the sets of the request types and the time series data of the total number of delays of all of the request types and stores the calculation results in the correlation coefficient table 143. The first partial correlation coefficient calculating unit 154 calculates the correlation coefficient between the time series data of the total number of calls of all of the request types and the time series data of the total number of delays of all of the request types and stores the calculation result in the correlation coefficient table 143.

Subsequently, after calculating each of the correlation coefficients, the first partial correlation coefficient calculating unit 154 performs a process for removing the effect of the overall trend from the correlation coefficients between each of the sets of the request types. For example, if both the time series data of the number of calls of the request type A and the request type of the number of delays of the request type B correlate with the total number of calls of all of the request types or correlates with the time series data of the total number of delays, the correlation coefficient between the request types A and B is increased. In order to remove such false correlation, the first partial correlation coefficient calculating unit 154 removes the effect of the overall trend from the correlation coefficients between each of the sets of the request types.

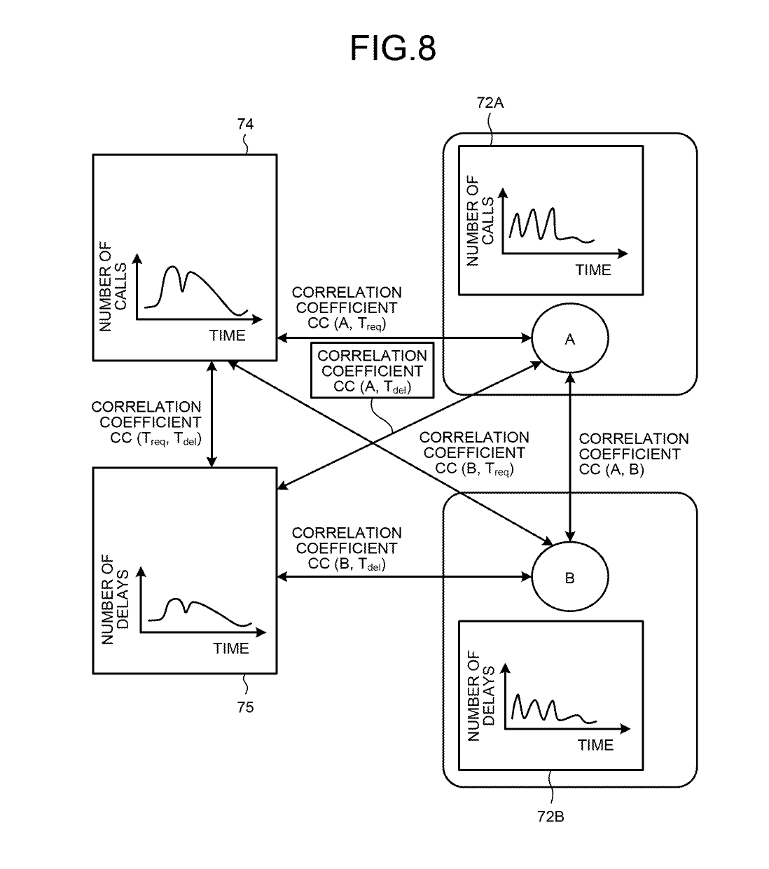

FIGS. 8 to 12 are schematic diagrams each illustrating an example of a process that removes the effect of the overall trend. Here, a description will be given of an example of calculating the first partial correlation coefficient PCC (A, B−T_{req}, T_{del}) that is obtained by removing the effect of the overall trend from the correlation coefficient between time series data 72A of the number of calls of the request type A and time series data 72B of the number of delays of the request type B. Although not described here; however, the first partial correlation coefficient calculating unit 154 performs the process illustrated in FIGS. 8 to 12 on each of the sets of the time series data of the number of calls of all of the request types and the time series data of the number of delays.

FIG. 8 will be described. The correlation coefficient between the time series data 72A of the number of calls of the request type A and the time series data 72B of the number of delays of the request type B is set to the correlation coefficient CC (A, B). The correlation coefficient between the time series data 72A and time series data 74 of the total number of calls of all of the request types is set to the correlation coefficient CC (A, T_{req}). The correlation coefficient between the time series data 72B and the time series data 74 is set to the correlation coefficient CC (B, T_{req}).

The correlation coefficient between the time series data 72A and time series data 75 of the total number of delays of all of the request types is set to the correlation coefficient CC (A, T_{del}). The correlation coefficient between the time series data 72B and the time series data 75 is set to the correlation coefficient CC (B, T_{del}). The correlation coefficient between the time series data 74 and the time series data 75 is set to the correlation coefficient CC (T_{req}, T_{del}).

The first partial correlation coefficient calculating unit 154 performs the following process and removes, one by one, the effect exerted by the total number of calls of all of the request types on another correlation coefficient. In FIG. 8, the first partial correlation coefficient calculating unit 154 calculates the partial correlation coefficient PCC (A, T_{del}−T_{req}) by removing the effect of the time series data 74 from the correlation coefficient CC (A, T_{del}). The first partial correlation coefficient calculating unit 154 calculates the partial correlation coefficient PCC (A, T_{del}−T_{req}) on the basis of Equation (1).

$$Partial correlation coefficient P C C ( A , {T}_{del} - {T}_{req} ) = \frac{C C ( A , {T}_{del} ) - C C ( A , {T}_{req} ) \times C C ( {T}_{req} , {T}_{del} )}{\sqrt{1 - C {C ( A , {T}_{req} )}^{2}} \sqrt{1 - C {C ( {T}_{req} , {T}_{del} )}^{2}}} \qquad ( 1 )$$

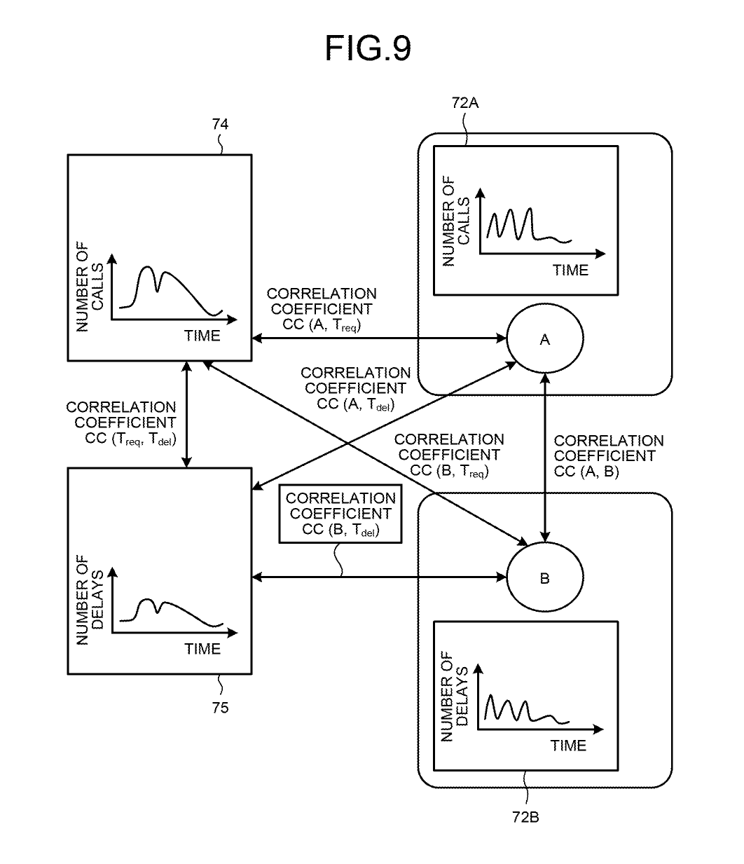

FIG. 9 will be described. The first partial correlation coefficient calculating unit 154 calculates the partial correlation coefficient PCC (B, T_{del}−T_{req}) by removing the effect of the time series data 74 from the correlation coefficient CC (B, T_{del}). The first partial correlation coefficient calculating unit 154 calculates the partial correlation coefficient PCC (B, T_{del}−T_{req}) on the basis of Equation (2).

$$Partial correlation coefficient P C C ( B , {T}_{del} - {T}_{req} ) = \frac{C C ( B , {T}_{del} ) - C C ( B , {T}_{req} ) \times C C ( {T}_{req} , {T}_{del} )}{\sqrt{1 - C {C ( B , {T}_{req} )}^{2}} \sqrt{1 - C {C ( {T}_{req} , {T}_{del} )}^{2}}} \qquad ( 2 )$$

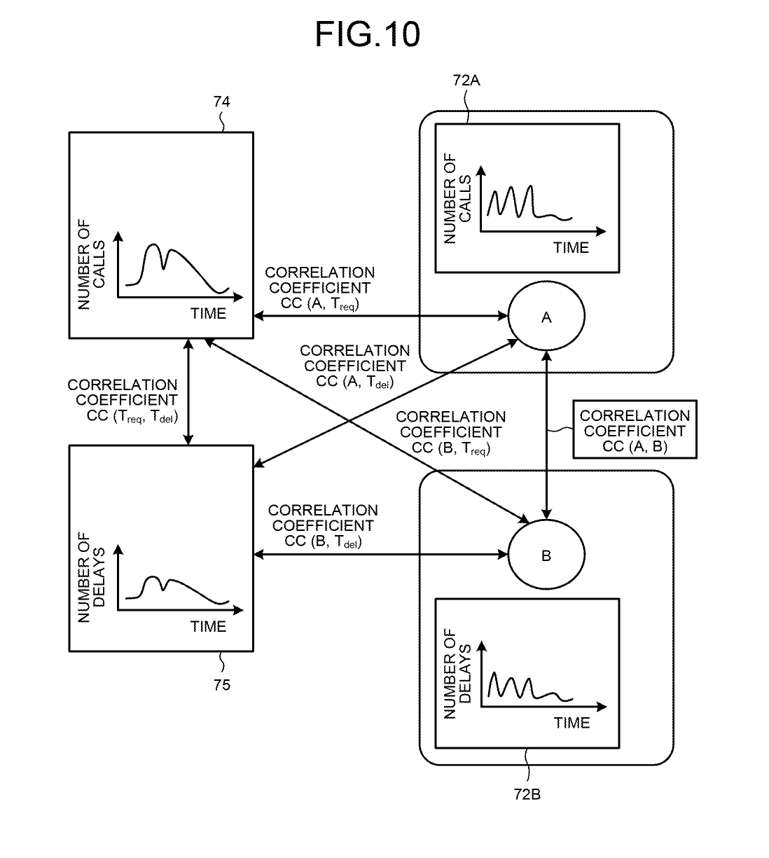

FIG. 10 will be described. The first partial correlation coefficient calculating unit 154 calculates the partial correlation coefficient PCC (A, B−T_{req}) by removing the effect of the time series data 74 from the correlation coefficient CC (A, B). The first partial correlation coefficient calculating unit 154 calculates the partial correlation coefficient PCC (A, B−T_{req}) on the basis of Equation (3).

$$Partial correlation coefficient P C C ( A , B - {T}_{req} ) = \frac{C C ( A , B ) - C C ( A , {T}_{req} ) \times C C ( B , {T}_{req} )}{\sqrt{1 - C {C ( A , {T}_{req} )}^{2}} \sqrt{1 - C {C ( B , {T}_{req} )}^{2}}} \qquad ( 3 )$$

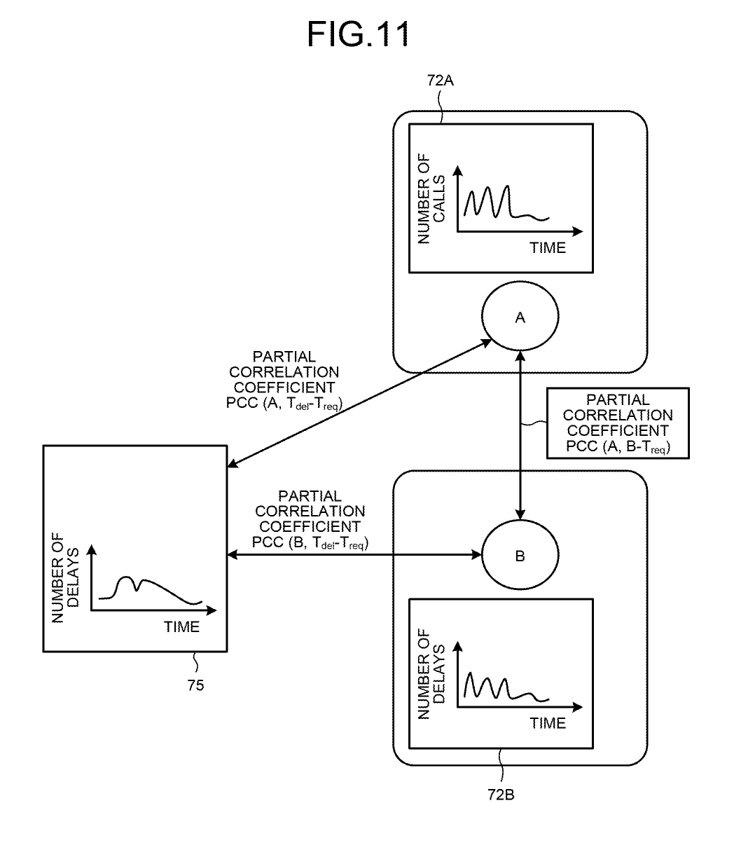

FIG. 11 will be described. The first partial correlation coefficient calculating unit 154 calculates the partial correlation coefficient PCC (A, B−T_{req}, T_{del}) by removing the effect of the time series data 75 from the partial correlation coefficient PCC (A, B−T_{req}). The first partial correlation coefficient calculating unit 154 calculates the partial correlation coefficient PCC (A, B−T_{req}, T_{del}) on the basis of Equation (4).

$$Partial correlation coefficient P C C ( A , B - {T}_{req} , {T}_{del} ) = \frac{P C C ( A , B - {T}_{req} ) - P C C ( A , {T}_{del} - {T}_{req} ) \times P C C ( {T}_{del} - {T}_{req} )}{\sqrt{1 - P C {C ( A , {T}_{del} - {T}_{req} )}^{2}} \sqrt{1 - P C {C ( {T}_{del} - {T}_{req} )}^{2}}} \qquad ( 4 )$$

Regarding the correlation coefficient between the time series data of the number of calls and the time series data of the number of delays, the first partial correlation coefficient calculating unit 154 calculates, by performing the process described above, the first partial correlation coefficient by removing the effect of the overall trend from the correlation coefficient. Furthermore, regarding also the correlation coefficient between the time series data of the number of delays and the time series data of the number of the other delays, the first partial correlation coefficient calculating unit 154 calculates, by performing the process described above, the first partial correlation coefficient by removing the effect of the overall trend from the correlation coefficient.

Here, regarding the correlation coefficient between the time series data of the number of calls and the time series data of the number of the other calls, only the effect that is exerted by the time series data of the total number of calls of all of the request types needs to be removed. Because the number of delays does not affect the number of calls of requests, the time series data of the total number of delays of all of the request types does not affect the correlation coefficient between the time series data of each of the numbers of calls.

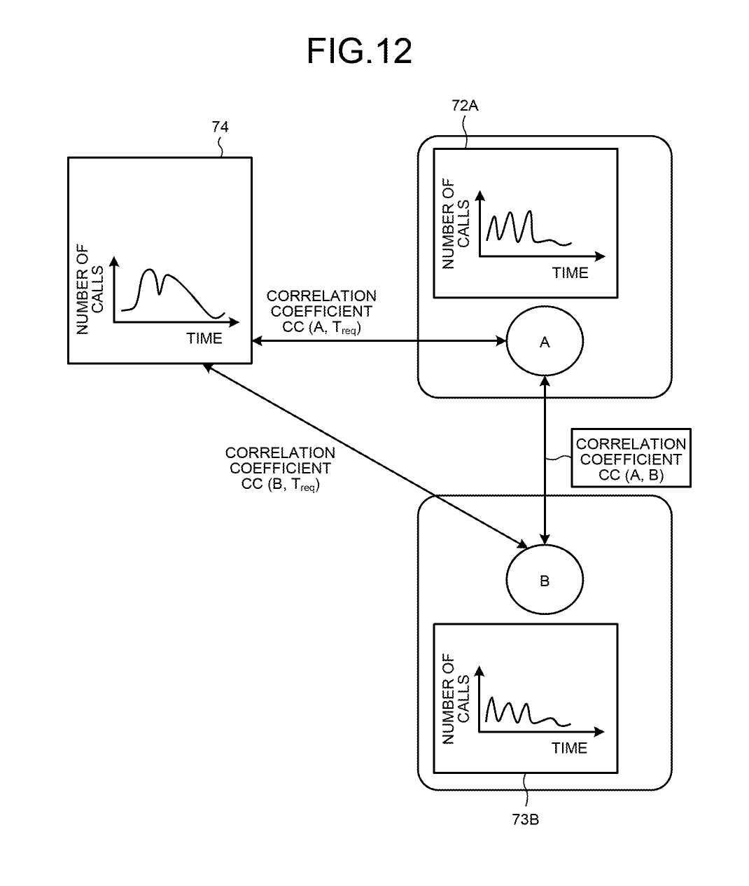

FIG. 12 will be described. The first partial correlation coefficient calculating unit 154 sets the correlation coefficient between the time series data 72A of the number of calls of the request type A and time series data 73B of the number of calls of the request type X to the correlation coefficient CC (A, B). The first partial correlation coefficient calculating unit 154 sets the correlation coefficient between the time series data 72A and time series data 74 of the total number of calls of all of the request types to the correlation coefficient CC (A, T_{req}). The first partial correlation coefficient calculating unit 154 sets the correlation coefficient between the time series data 73B and the time series data 74 of the total number of calls of all of the request types to the correlation coefficient CC (B, T_{req}).

The first partial correlation coefficient calculating unit 154 calculates the partial correlation coefficient PCC (A, B−T_{req}) by removing the effect of the time series data 74 from the correlation coefficient CC (A, B). The first partial correlation coefficient calculating unit 154 calculates the partial correlation coefficient PCC (A, B−T_{req}) on the basis of Equation (5). This partial correlation coefficient corresponds to the first partial correlation coefficient.

$$Partial correlation coefficient P C C ( A , B - {T}_{req} ) = \frac{C C ( A , B ) - C C ( A , {T}_{req} ) \times C C ( B , {T}_{req} )}{\sqrt{1 - C {C ( A , {T}_{req} )}^{2}} \sqrt{1 - C {C ( B , {T}_{req} )}^{2}}} \qquad ( 5 )$$

The first partial correlation coefficient calculating unit 154 calculates the first partial correlation coefficient by performing the process described above and stores the calculation result in the first partial correlation coefficient table 144.

A description will be given here by referring back to FIG. 2. The second partial correlation coefficient calculating unit 155 is a processing unit that calculates a second partial correlation coefficient by comprehensively removing, by using the partial correlation analysis, the reciprocal effect between the request types from the first partial correlation coefficient between each of the request types. For example, it is assumed that the time series data of the number of calls of the request type A and the time series data of the number of calls of the request type B have correlation. Then, in some cases, even if there is no correlation between the time series data of the number of delays of the request type A and the time series data of the number of delays of the request type B, the correlation coefficient may possibly be increased. In order to remove such false correlation, the second partial correlation coefficient calculating unit 155 comprehensively removes, by using the partial correlation analysis, the reciprocal effect between the request types from the first partial correlation coefficient.

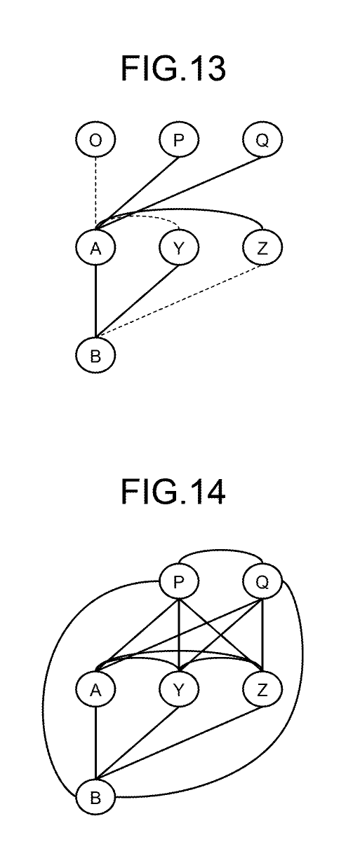

FIGS. 13 to 28 are schematic diagrams each illustrating an example of a process that comprehensively removes the reciprocal effects between the request types by using the partial correlation analysis. Here, as an example, a description will be given of a case in which the reciprocal effect is comprehensively removed from the first partial correlation coefficient between the time series data of the number of delays of the request type A and the time series data of the number of delays of the request type B by using the partial correlation analysis.

Regarding the time series data of the number of delays of the request types A and B, the second partial correlation coefficient calculating unit 155 selects all of the pieces of the time series data of the number of delays (or the number of calls) of all of the request types that possibly affect the correlation coefficient (the first partial correlation coefficient) between the subject request types A and B.

The second partial correlation coefficient calculating unit 155 checks the correlation coefficient between the time series data of the number of calls (or the number of delays) of a certain request type X and the request data of the number of delays of the request type A by using a level of significance α1. If a significant correlation is recognized from the result of the check, the second partial correlation coefficient calculating unit 155 selects the time series data of the number of calls (or the number of delays) of the request type X.

Similarly, the second partial correlation coefficient calculating unit 155 checks the correlation coefficient between the time series data of the number of calls (or the number of delays) of the certain request type X and the request data of the number of delays of the request type B by using a level of significance α1. If a significant correlation is recognized from the result of the check, the second partial correlation coefficient calculating unit 155 selects the time series data of the number of calls (or the number of delays) of the request type S.

For example, if the level of significance α1 is set to “0.10” and the first partial correlation coefficient between the request types X and A is equal to or greater than “0.10”, the second partial correlation coefficient calculating unit 155 selects the time series data of the number of calls (or the number of delays) of the request type X. The second partial correlation coefficient calculating unit 155 acquires the correlation coefficient between the request types from the first partial correlation coefficient table 144. In a description of FIGS. 13 to 28, a partial correlation coefficient between the time series data of the number of calls or the number of delays of a certain request type and the time series data of the number of calls or the number of delays of another request type is appropriately and simply referred to as a partial correlation coefficient between a certain request type and another request type.

FIG. 13 will be described. For example, it is assumed that the partial correlation coefficient between the request type A and each of the request types P, Q, and Z indicates that they have a significant correlation at the level of significance α1. Furthermore, it is assumed that the partial correlation coefficient between the request type B and the request type Y indicates that they have a significant correlation at a level of significance α1. Here, it is assumed that, from among the request type candidates O, P, Q, Y, and Z, the request type O does not have a partial correlation coefficient between the request types A and B at the level of significance α1. Consequently, the second partial correlation coefficient calculating unit 155 selects the request types P, Q, Y, and Z.

For example, a case in which a certain request type and another request type have a significant correlation at the level of significance α1 indicates that the partial correlation coefficient between the certain request type and the other request type is equal to or greater than the level of significance α1. Furthermore, the value of the level of significance α1 may also appropriately be modified on the basis of the number of samples of the request type or the like.

FIG. 14 will be described. The second partial correlation coefficient calculating unit 155 combines the selected request types. Namely, the second partial correlation coefficient calculating unit 155 combines the request type A with the request types P, Q, Y, and Z. The second partial correlation coefficient calculating unit 155 combines the request type B with the request types P, Q, Y, and Z. The second partial correlation coefficient calculating unit 155 combines the request type Y with the request types A, B, Z, P, and Q. The second partial correlation coefficient calculating unit 155 combines the request type Z with the request types A, B, Y, P, and Q. The second partial correlation coefficient calculating unit 155 combines the request type P with the request types A, B, Y, Z, and Q. The second partial correlation coefficient calculating unit 155 combines the request type Q with the request types A, X, Y, Z, and P. The initial value of each of the links corresponds to the first partial correlation coefficient between the request types of the link at both ends.

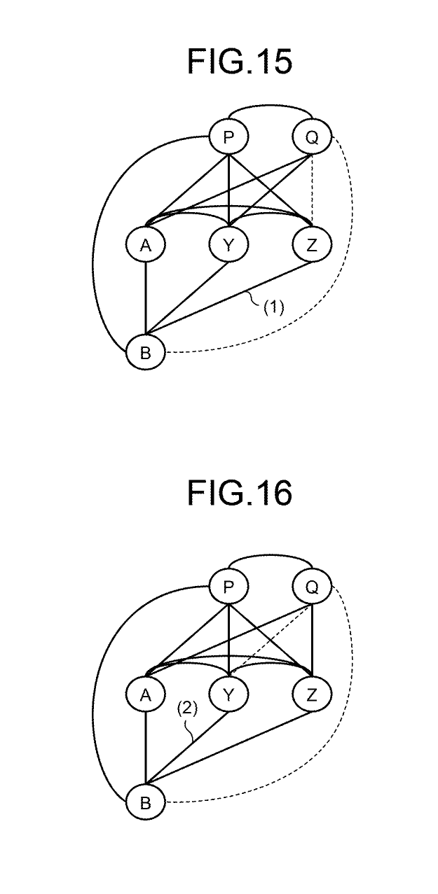

As will be described with reference to FIGS. 15 to 29 below, the second partial correlation coefficient calculating unit 155 removes a single request type and reflects the effect of the removed request type to the first partial correlation coefficient between the request types that are combined by two links from the subject request types.

FIG. 15 will be described. The second partial correlation coefficient calculating unit 155 removes the request types P, Q, Y, and Z one by one. Before the second partial correlation coefficient calculating unit 155 removes the request types, the second partial correlation coefficient calculating unit 155 reflects the effects of the request types, which will be removed, to the partial correlation coefficient between the request types that are combined by the links. In the following, a case of removing the request type Q will be described. When the second partial correlation coefficient calculating unit 155 removes the request type Q, the second partial correlation coefficient calculating unit 155 updates the partial correlation coefficient between the request types Z and B (1) on the basis of the partial correlation coefficient between the request types Z and B (1), the partial correlation coefficient between the request types Q and Z, and the partial correlation coefficient between the request types Q and B. For example, the second partial correlation coefficient calculating unit 155 calculates the partial correlation coefficient between the request types Z and B (1) on the basis of Equation (6) and updates the partial correlation coefficient between the request types Z and B. Equation (6) corresponds to an equation that is used to calculate a typical partial correlation coefficient. Because the calculation equation that is used to calculate the partial correlation coefficient corresponds to an equation that is used to calculate a typical partial correlation coefficient, in the following description, a specific equation will be omitted.

$$Partial correlation coefficient P C C ( Z , B - {T}_{req} ) = \frac{C C ( Z , B ) - C C ( Z , Q ) \times C C ( B , Q )}{\sqrt{1 - C {C ( Z , Q )}^{2}} \sqrt{1 - C {C ( B , Q )}^{2}}} \qquad ( 6 )$$

FIG. 16 will be described. When the second partial correlation coefficient calculating unit 155 removes the request type Q, the second partial correlation coefficient calculating unit 155 updates the partial correlation coefficient between the request types Y and B (2) on the basis of the partial correlation coefficient between the request types Y and B (2), the partial correlation coefficient between the request types Q and Y, and the partial correlation coefficient between the request types Q and B.

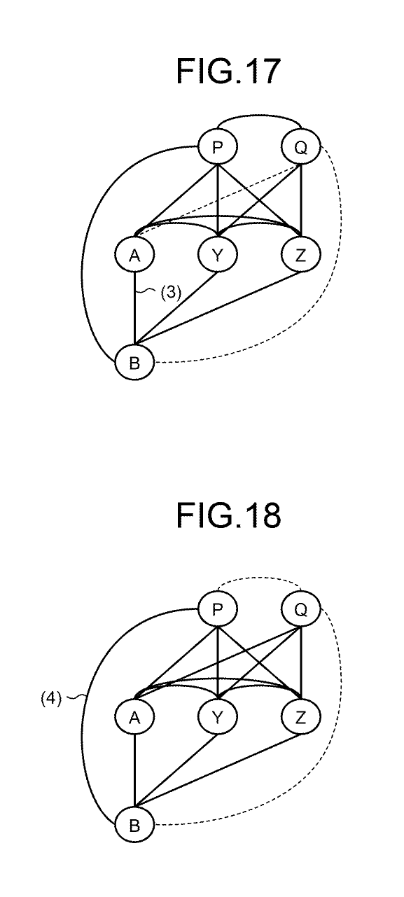

FIG. 17 will be described. When the second partial correlation coefficient calculating unit 155 removes the request type Q, the second partial correlation coefficient calculating unit 155 updates the partial correlation coefficient between the request types A and B (3) on the basis of the partial correlation coefficient between the request types A and B (3), the partial correlation coefficient between the request types Q and A, and the partial correlation coefficient between the request types Q and B.

FIG. 18 will be described. When the second partial correlation coefficient calculating unit 155 removes the request type Q, the second partial correlation coefficient calculating unit 155 updates the partial correlation coefficient between the request types P and B (4) on the basis of the partial correlation coefficient between the request types P and B (4), the partial correlation coefficient between the request types Q and P, and the partial correlation coefficient between the request types Q and B.

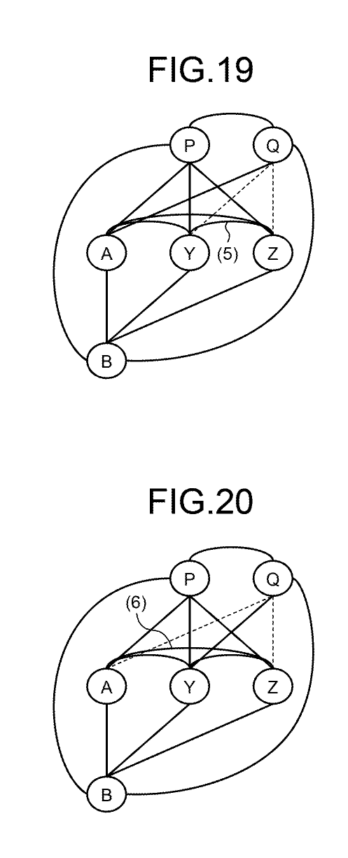

FIG. 19 will be described. When the second partial correlation coefficient calculating unit 155 removes the request type Q, the second partial correlation coefficient calculating unit 155 updates the partial correlation coefficient between the request types Y and Z (5) on the basis of the partial correlation coefficient between the request types Y and Z (5), the partial correlation coefficient between the request types Q and Y, and the partial correlation coefficient between the request types Q and Z.

FIG. 20 will be described. When the second partial correlation coefficient calculating unit 155 removes the request type Q, the second partial correlation coefficient calculating unit 155 updates the partial correlation coefficient between the request types A and Z (6) on the basis of the partial correlation coefficient between the request types A and Z (6), the partial correlation coefficient between the request types Q and A, and the partial correlation coefficient between the request types Q and Z.

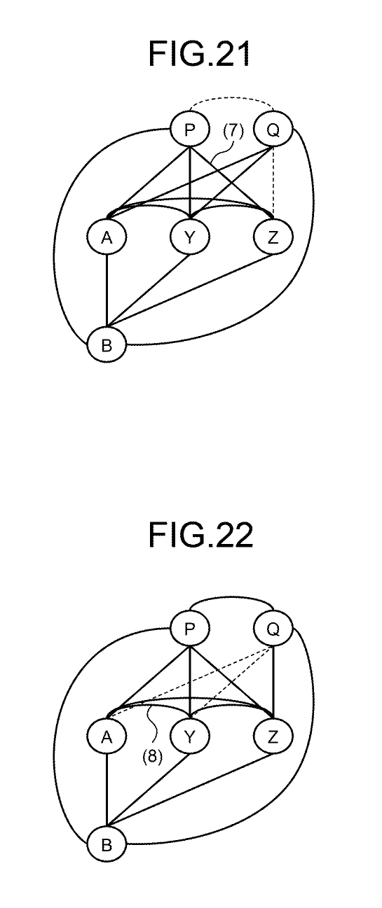

FIG. 21 will be described. When the second partial correlation coefficient calculating unit 155 removes the request type Q, the second partial correlation coefficient calculating unit 155 updates the partial correlation coefficient between the request types P and Z (7) on the basis of the partial correlation coefficient between the request types P and Z (7), the partial correlation coefficient between the request types Q and P, and the partial correlation coefficient between the request types Q and Z.

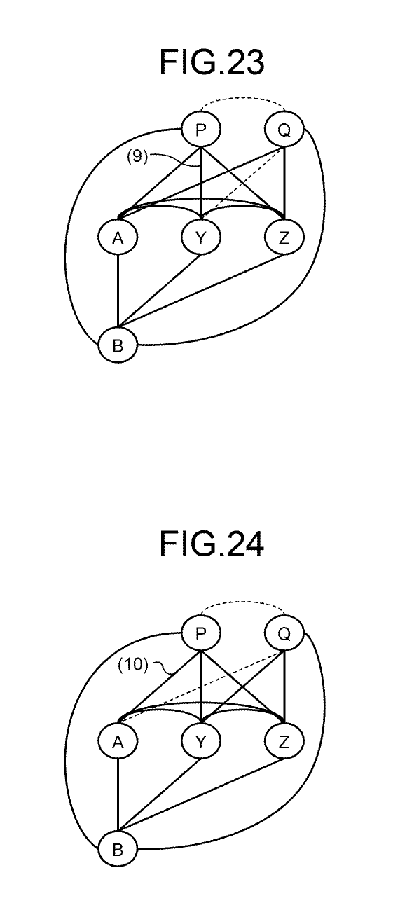

FIG. 22 will be described. When the second partial correlation coefficient calculating unit 155 removes the request type Q, the second partial correlation coefficient calculating unit 155 updates the partial correlation coefficient between the request types A and Y (8) on the basis of the partial correlation coefficient between the request types A and Y (8), the partial correlation coefficient between the request types Q and A, and the partial correlation coefficient between the request types Q and Y.

FIG. 23 will be described. When the second partial correlation coefficient calculating unit 155 removes the request type Q, the second partial correlation coefficient calculating unit 155 updates the partial correlation coefficient between the request types P and Y (9) on the basis of the partial correlation coefficient between the request types P and Y (9), the partial correlation coefficient between the request types Q and P, and the partial correlation coefficient between the request types Q and Y.

FIG. 24 will be described. When the second partial correlation coefficient calculating unit 155 removes the request type Q, the second partial correlation coefficient calculating unit 155 updates the partial correlation coefficient between the request types P and A (10) on the basis of the partial correlation coefficient between the request types P and A (10), the partial correlation coefficient between the request types Q and P, and the partial correlation coefficient between the request types Q and A.

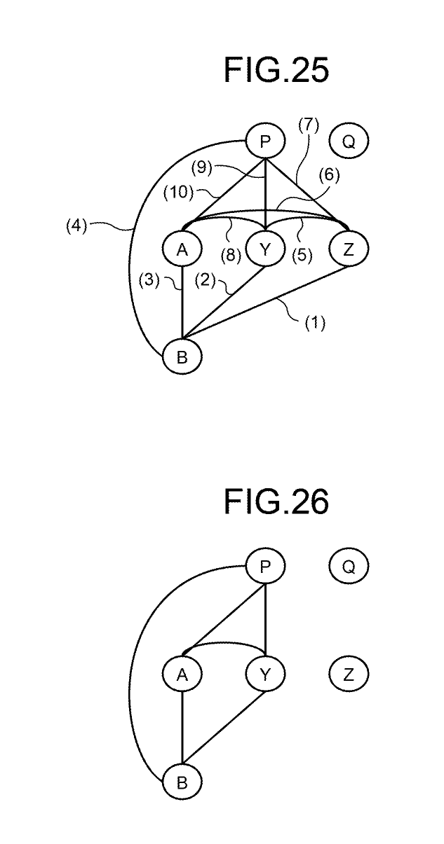

FIG. 25 will be described. By performing the process illustrated in FIGS. 15 to 24, the second partial correlation coefficient calculating unit 155 updates the partial correlation coefficient between each of the sets of the request types (1) to (10) and removes the effect of the request type Q. After removing the effect of the request type Q, the second partial correlation coefficient calculating unit 155 the removes the request type Q.

FIG. 26 will be described. Similarly to the case of removing the effect of the request type Q, by removing the effect of the request type Z from each of the partial correlation coefficients between the respective sets of the request types, the second partial correlation coefficient calculating unit 155 updates the value of each of the partial correlation coefficients between the respective sets of the request types. After removing the effect of the request type Z, the second partial correlation coefficient calculating unit 155 removes the request type Z.

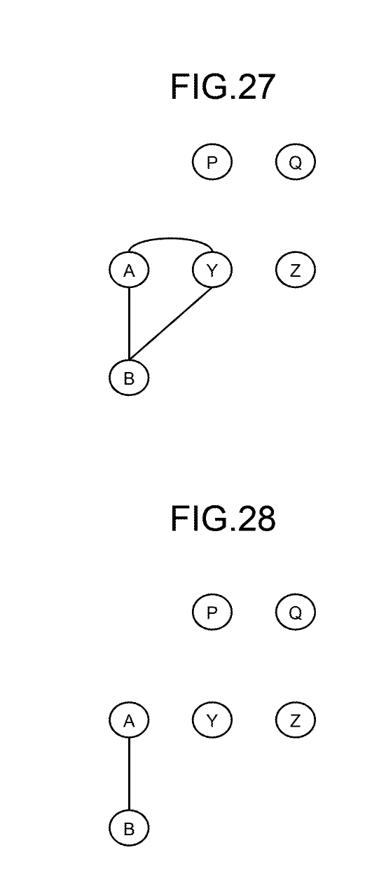

FIG. 27 will be described. Similarly to the case of removing the effect of the request type Q, by removing the effect of the request type P from each of the partial correlation coefficients between the respective sets of the request types, the second partial correlation coefficient calculating unit 155 updates the value of each of the partial correlation coefficients between the respective sets of the request types. After removing the effect of the request type P, the second partial correlation coefficient calculating unit 155 removes the request type P.

FIG. 28 will be described. Similarly to the case of removing the effect of the request type Q, by removing the effect of the request type Y from each of the partial correlation coefficients between the respective sets of the request types, the second partial correlation coefficient calculating unit 155 updates the value of each of the partial correlation coefficients between the respective sets of the request types. After removing the effect of the request type Y, the second partial correlation coefficient calculating unit 155 removes the request type Y.

By performing the processed illustrated in FIGS. 13 to 28, the second partial correlation coefficient calculating unit 155 comprehensively removes the reciprocal effect between the request types from the partial correlation coefficient between the request type A and the request type B by using the partial correlation analysis. The second partial correlation coefficient calculating unit 155 stores, in the second partial correlation coefficient table 145, the partial correlation coefficient (the second partial correlation coefficient) between the finally obtained request type A and the request type B. Regarding the partial correlation coefficients between the other request types, by performing the processes associated in FIGS. 13 to 28, the second partial correlation coefficient calculating unit 155 comprehensively removes the reciprocal effect between the request types from the partial correlation coefficient between the respective sets of the request types by using the partial correlation analysis.

In the examples illustrated in FIGS. 13 to 28, a description has been given of a case in which the reciprocal effect is comprehensively removed, by using the partial correlation analysis, from the first partial correlation coefficient between the time series data of the number of delays of the request type A and the time series data of the number of delays of the request type B. The second partial correlation coefficient calculating unit 155 comprehensively removes, by using the partial correlation analysis in a similar manner, the reciprocal effect from the first partial correlation coefficient between the time series data of the number of delays of the request type A and the time series data of the number of calls of the request types.

Because the first partial correlation coefficient calculating unit 154 and the second partial correlation coefficient calculating unit 155 described above perform the processes, the partial correlation coefficient registered in the second partial correlation coefficient table 145 becomes the partial correlation coefficient that is obtained by comprehensively removing the effect of the overall trend and the reciprocal effect.

A description will be given here by referring back to FIG. 2. The determination unit 156 is a processing unit that determines, on the basis of the second partial correlation coefficient table 145, the set of request types having a significant correlation and that outputs the determination result. For example, it is assumed that, regarding the set of the number of calls of the request type A and the number of delays of the request type B, the determination unit 156 determines that both have a significant correlation. In such a case, the determination unit 156 determines that the number of calls of the request type A affects the effect of the number of delays of the request type B.

Furthermore, regarding the set of the number of delays of the request type A and the number of delays of the request type B, the determination unit 156 determines that both have a significant correlation. In this case, the determination unit 156 determines that one of the number of delays of the request type A and the number of delays of the request type B affects the other one of the number of delays.

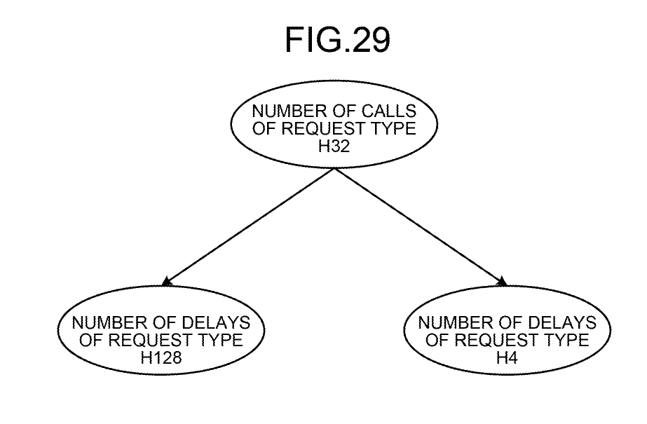

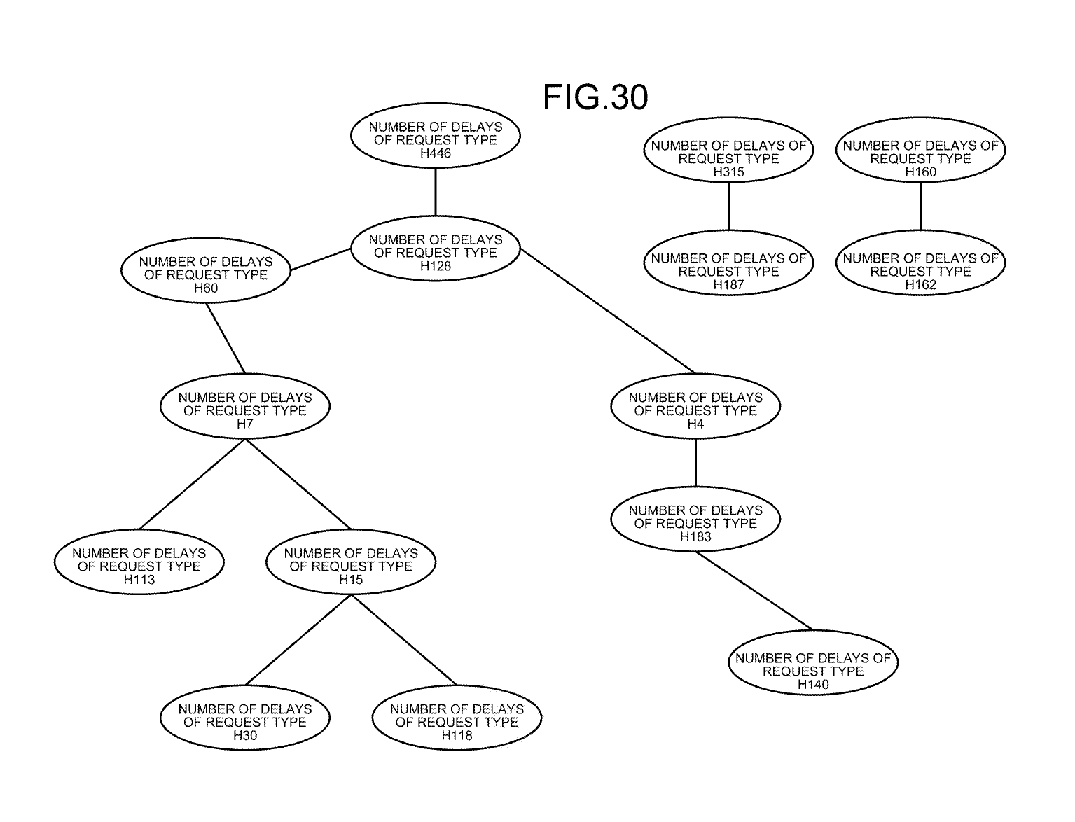

The determination unit 156 may also visualize the determination result and output the determination result to the displaying unit 130. FIGS. 29 and 30 are schematic diagrams each illustrating an example of the visualized determination results. In the example illustrated in FIG. 29, it is assumed that the number of calls of a request type H32 and the number of delays of a request type H128 have a significant correlation and it is assumed that the number of calls of a request type H32 and the number of delays of a request type H4 have a significant correlation. In this case, the determination unit 156 determines that the number of calls of the request type H32 causes the delay of the request types H128 and H4. For example, the determination unit 156 creates the arrows from the node associated with the number of calls of the request type H32 toward the nodes associated with the request types H128 and H4.

The example illustrated in FIG. 30 indicates a case in which the number of delays of a request type H446 and the number of delays of a request type H128 have a significant correlation and a case in which the number of delays of the request type H128 and the number of delays of request types H60 and H4 have a significant correlation. The example illustrated in FIG. 30 indicates a case in which the number of delays of a request type H60 and the number of delays of a request type H7 have a significant correlation and a case in which the number of delays of the request type H7 and the number of delays of the request types H113 and H15 have a significant correlation. Furthermore, the example illustrated in FIG. 30 indicates a case in which the number of delays of the request type H15 and the number of delays of the request types H30 and H118 have a significant correlation.

The example illustrated in FIG. 30 indicates a case in which the number of delays of the request type H4 and the number of delays of the request type H183 have a significant correlation and a case in which the number of delays of the request type H183 and the number of delays of the request type H140 have a significant correlation. The example illustrated in FIG. 30 indicates a case in which the number of delays of the request type H315 and the number of delays of the request type H187 have a significant correlation and a case in which the number of delays of the request type H160 and the number of delays of the request type H162 have a significant correlation.

Furthermore, when the determination unit 156 displays the determination result illustrated in FIG. 30, the determination unit 156 may also combine each of the request type by using the line with the thickness that is in accordance with the value of the second partial correlation coefficient between the number of delays of the respective sets of the request types.

Furthermore, when the determination unit 156 displays the determination result illustrated in FIG. 30, the determination unit 156 may also calculate the score for each node associated with each of the request types and narrow down the candidates for the cause of the delay. The determination unit 156 calculates the score for each node on the basis of Equation (7). In Equation (7), PCC (x, i) represents the second partial correlation coefficient between a node x that is associated with the number of delays of a certain request type and a node i that is associated with the number of delays of another request type.

$$s ( x ) = {\sum }_{i = 1}^{n} ( PCC ( x , i ) ) \qquad ( 7 )$$

As an example, a case in which the determination unit 156 calculates the score of the node associated with the number of delays of the request type H128. The determination unit 156 calculates the score of the node associated with the number of delays of the request type H128 by summing the second partial correlation coefficient between the node associated with the number of delays of the request type H128 and each of the nodes associated with the number of delays of the request types H446, H60, H4. The determination unit 156 also similarly calculates the score of the node associated with the other request types.

After calculating the score of each of the nodes, the determination unit 156 compares the scores between adjacent nodes and marks the node that has a low score. When the determination unit 156 compares the scores, if both of the scores are close within a certain rate, the determination unit 156 does not mark any of the scores. Furthermore, if the adjacent nodes are the node associated with the number of delays of the request type and the node associated with the number of calls of the request type, the determination unit 156 marks the node associated with the number of delays irrespective of the scores.

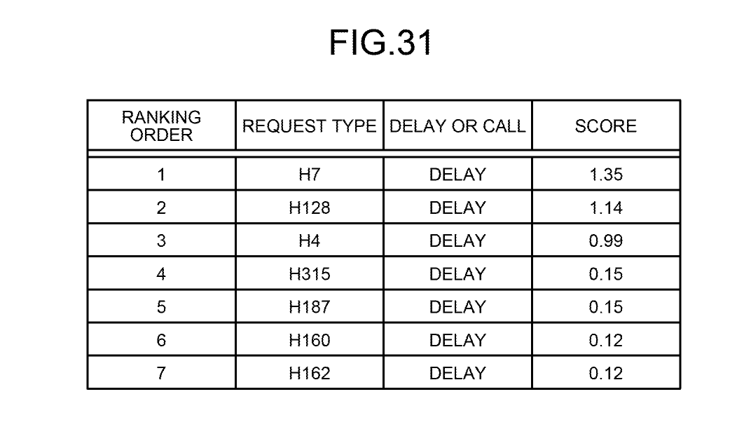

The determination unit 156 ranks the remaining unmarked nodes in descending order of the scores. The possibility of the cause of a delay is high for a node as the score is higher. FIG. 31 is a schematic diagram illustrating an example of a ranking list created by a determination unit. As illustrated in FIG. 31, this ranking list associates the ranking order, the request type, a delay or a call, and a score. From among these items, the ranking order indicates the order of possible causes of a delay and the request type is information for uniquely identifying a request. The delay or the call is information for identifying the subject node indicating whether the subject node is a node that is associated with the number of delays of the request type or a node that is associated with the number of calls of the request type. The score is the score calculated by Equation (7).

Furthermore, instead of Equation (7), the determination unit 156 may also calculate the score of each of the nodes on the basis of Equation (8). In Equation (8), d(x) represents the number of delays of a node x and α represents the weight that is appropriately set.

$$s ( x ) = d ( x ) + α {\sum }_{i = 1}^{n} ( d ( i ) \times PCC ( x , i ) ) \qquad ( 8 )$$

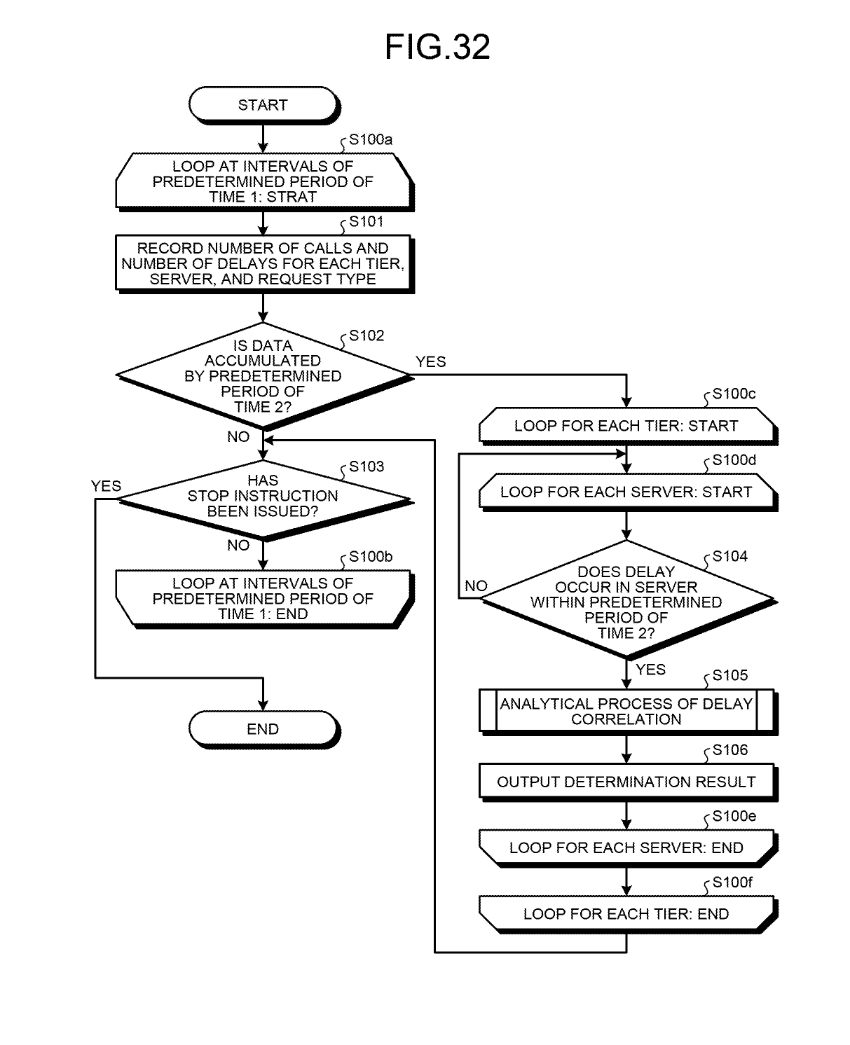

In the following, the flow of a process performed by the delay information output device according to the embodiment will be described. FIG. 32 is a flowchart illustrating the flow of a process performed by a delay information output device according to the embodiment. As illustrated in FIG. 32, the delay information output device 100 loops the processes from Step S100a to Step S100b at intervals of predetermined period of time 1. The first and the second creating units 152 and 153 in the delay information output device 100 record the number of calls and the number of delays for each tier, server, and request type (Step S101).

The delay information output device 100 determines whether data is accumulated in a predetermined period of time 2 (Step S102). If data is accumulated in the predetermined period of time 2 (Yes at Step S102), the delay information output device 100 proceeds to Step S100c. If data is not accumulated in the predetermined period of time 2 (No at Step S102), the delay information output device 100 proceeds to Step S103.

If a stop instruction is issued (Yes at Step S103), the delay information output device 100 ends the stop process. If a stop instruction is issued (No at Step S103), the delay information output device 100 proceeds to Step S100b.

The delay information output device 100 loops the processes from Steps S100c to S100f for each tier. Furthermore, the delay information output device 100 loops the processes from Steps S100d to S100e for each server.

The delay information output device 100 determines whether a delay occurs in the server in the predetermined period of time 2 (Step S104). If a delay occurs in the server in the predetermined period of time 2 (Yes at Step S104), the delay information output device 100 proceeds to Step S105. In contrast, if no delay occurs in the server (No at Step S104), the delay information output device 100 proceeds to Step S100d.

Each of the first and the second partial correlation coefficient calculating units 154 and 155 in the delay information output device 100 performs the analytical process of the delay correlation (Step S105). The determination unit 156 in the delay information output device 100 outputs the determination result (Step S106) proceeds to Step S100e.

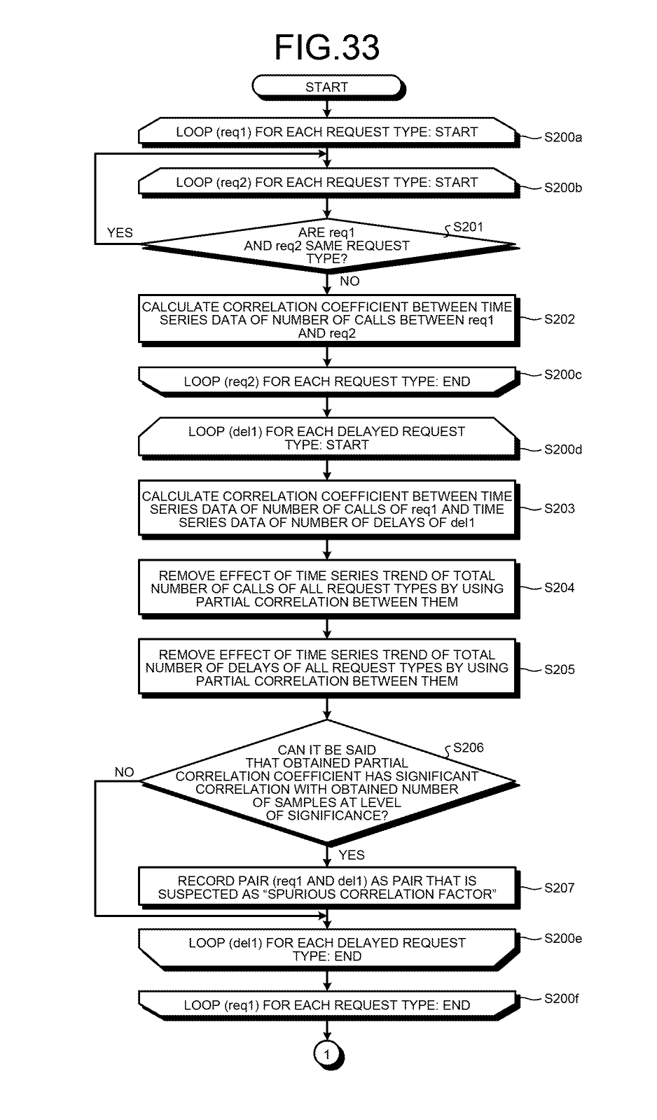

In the following, the analytical process of the delay correlation indicated at Step S105 illustrated in FIG. 32 will be described. FIGS. 33 to 35 are flowcharts each illustrating the flow of an analytical process of the delay correlation. As illustrated in FIG. 33, the first partial correlation coefficient calculating unit 154 in the delay information output device 100 selects the number of calls (req1) for each request type and loops the processes at Step S200a to S200f. The first partial correlation coefficient calculating unit 154 loops the number of calls (req2) for each request type and selects the steps S200b to S200c.

The first partial correlation coefficient calculating unit 154 determines whether both the number of calls req1 and req2 are the same request type (Step S201). If both the number of calls req1 and req2 are the same request type (Yes at Step S201), the first partial correlation coefficient calculating unit 154 proceeds to Step S200b. If both the number of calls of req1 and req2 are not the same request type (No at Step S201), the first partial correlation coefficient calculating unit 154 proceeds to Step S202.

The first partial correlation coefficient calculating unit 154 calculates the correlation coefficient between time series data of the number of calls of req1 and req2 (Step S202) and proceeds to Step S200c.

The first partial correlation coefficient calculating unit 154 selects the number of delays (del1) for each request type in which a delay occurs and then loops the processes from Step S200d to s200e. The first partial correlation coefficient calculating unit 154 calculates the correlation coefficient between the time series data of the number of calls of req1 and the time series data of the number of delays of del1 (Step S203).

The first partial correlation coefficient calculating unit 154 removes the effect of the time series trend of the total number of calls of all of the request types by using the partial correlation between them (Step S204). The first partial correlation coefficient calculating unit 154 removes the effect of the time series trend of the total number of delays of all of the request types by using the partial correlation between them (Step S205).

If it can be said that the obtained partial correlation coefficient has a significant correlation with the obtained number of samples at a level of significance (Yes at Step S206), the first partial correlation coefficient calculating unit 154 proceeds to Step S207. If it is not able to be said that the obtained partial correlation coefficient have a significant correlation with the obtained number of samples at a level of significance (No at Step S206), the first partial correlation coefficient calculating unit 154 proceeds to Step S200e.

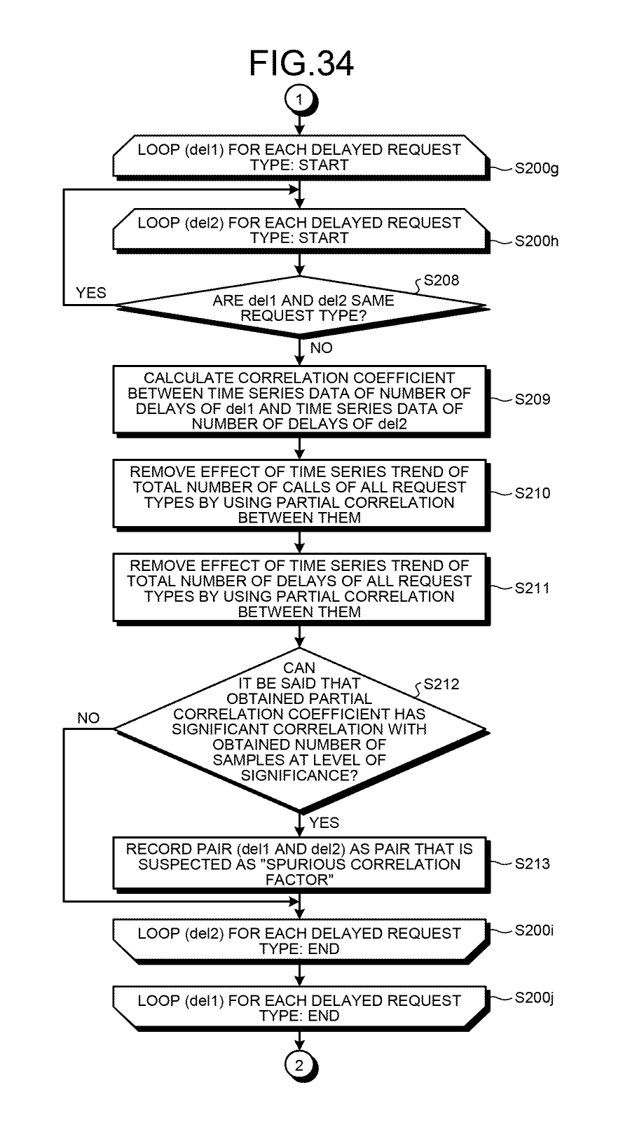

The first partial correlation coefficient calculating unit 154 records the pair (req1 and del1) as a pair that is suspected as the “spurious correlation factor” (Step S207) and proceeds to Step S200e. The delay information output device 100 proceeds to Step S200g illustrated in FIG. 34 after performing the process at Step S200f.

FIG. 34 will be described. The second partial correlation coefficient calculating unit 155 selects the number of delays (del1) for each delayed request type and then loops the processes at Steps S200g to S200j. The second partial correlation coefficient calculating unit 155 selects the number of delays (del2) for each delayed request type and then loops the processes at Steps S200h to S200i.

If del1 and del2 are the same request type (Yes at Step S208), the second partial correlation coefficient calculating unit 155 proceeds to Step S200h. If del1 and del2 are not the same request type (No at Step S208), the second partial correlation coefficient calculating unit 155 proceeds to Step S209.

The second partial correlation coefficient calculating unit 155 calculates the correlation coefficient between the time series data of the number of delays of del1 and the time series data of the number of delays of del2 (Step S209). The second partial correlation coefficient calculating unit 155 removes the effect of the time series trend of the total number of calls of all of the request types by using the partial correlation between them (Step S210). The second partial correlation coefficient calculating unit 155 removes the effect of the time series trend of the total number of delays of all of the request types by using the partial correlation between them (Step S211).

If it can be said that the obtained partial correlation coefficient has a significant correlation with the obtained the number of samples at a level of significance (Yes at Step S212), the second partial correlation coefficient calculating unit 155 proceeds to Step S213. If it is not able to be said that the obtained partial correlation coefficient have a significant correlation with the obtained number of samples at a level of significance (No at Step S212), the second partial correlation coefficient calculating unit 155 proceeds to Step S200i.

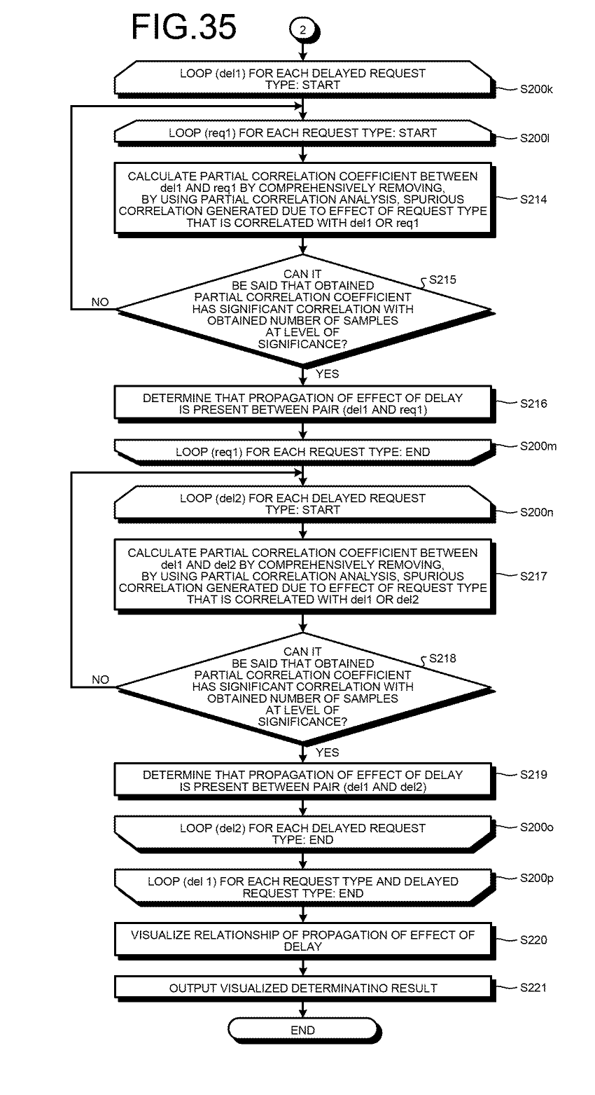

The second partial correlation coefficient calculating unit 155 records the pair (del1 and del2) as a pair that is suspected as the “spurious correlation factor” (Step S213) and proceeds to Step S200i. The delay information output device 100 proceeds to Step S200k illustrated in FIG. 35 after performing the process at Step S200j.

FIG. 35 will be described. The second partial correlation coefficient calculating unit 155 selects the number of delays (del1) for each delayed request type and then loops the processes at Steps S200k to S200p. The second partial correlation coefficient calculating unit 155 selects the number of calls for each request type and then loops the processes at Steps S200l to S200m.

The second partial correlation coefficient calculating unit 155 calculates the partial correlation coefficient between del1 and req1 that is obtained by comprehensively removing, by using the partial correlation analysis, the spurious correlation generated due to the effect of the request type that is correlated with del1 or req1 (Step S214).

If it can be said that the obtained partial correlation coefficient has a significant correlation with the obtained number of samples at a level of significance (Yes at Step S215), the second partial correlation coefficient calculating unit 155 proceeds to Step S216. If it is not able to be said that the obtained partial correlation coefficient have a significant correlation with the obtained number of samples at a level of significance (No at Step S215), the second partial correlation coefficient calculating unit 155 proceeds to Step S200l.

The determination unit 156 determines that propagation of the effect of the delay is present between the pair (del1 and req1), outputs the determination result (Step S216), and proceeds to Step S200m.

The second partial correlation coefficient calculating unit 155 selects the number of delays (del2) of the delayed request type and loops the processes at Steps S200n to S200o. The second partial correlation coefficient calculating unit 155 calculates the partial correlation coefficient between del1 and req1 obtained by comprehensively removing, by using the partial correlation analysis, the spurious correlation generated due to the effect of the request type that is correlated with del1 or del2 (Step S217).

If it is not able to be said that the obtained partial correlation coefficient have a significant correlation with the obtained number of samples at a level of significance (No at Step S218), the second partial correlation coefficient calculating unit 155 proceeds to Step S200n. If it can be said that the obtained partial correlation coefficient has a significant correlation with the obtained the number of samples at a level of significance (Yes at Step S218), the second partial correlation coefficient calculating unit 155 proceeds to Step S219.

The determination unit 156 determines that propagation of the effect of the delay is present between the pair (del1 and del2) and outputs the determination result (Step S219). After the process at Step S200p, the determination unit 156 visualizes the relationship of propagation of the effect of the delay (Step S220) and outputs the visualized determination result (Step S221).

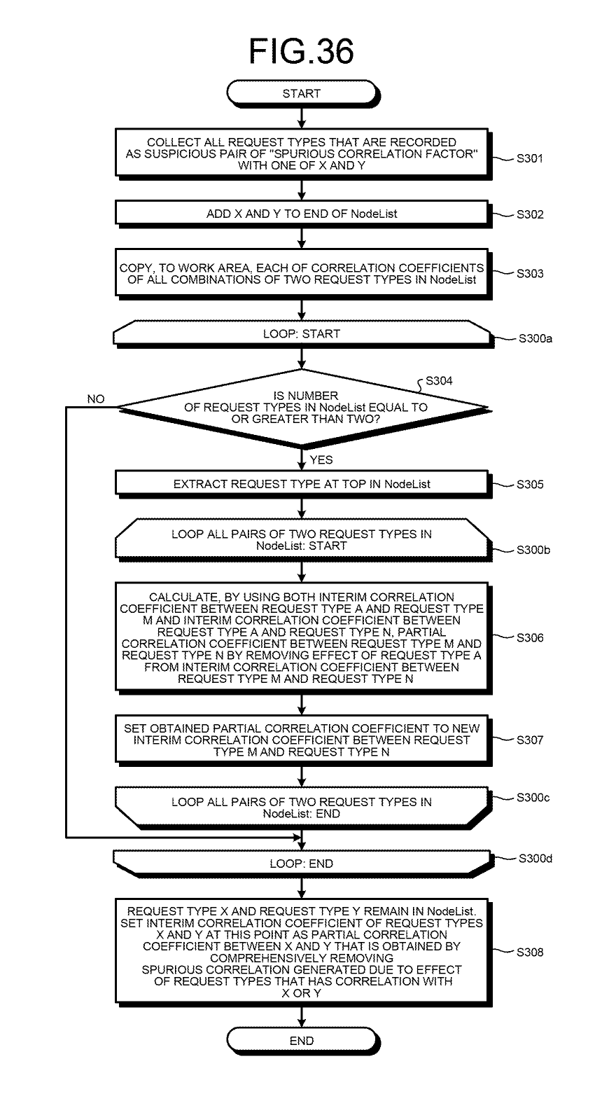

In the following, the flow of a process in which the second partial correlation coefficient calculating unit 155 comprehensively removes the reciprocal effect between the request types by using the partial correlation analysis will be described. FIG. 36 is a flowchart illustrating the flow of a process that comprehensively removes the reciprocal effects between the request types by using the partial correlation analysis. In a description illustrated in FIG. 36, the two request types are respectively represented by X and Y. The second partial correlation coefficient calculating unit 155 collects all of the request types that are recorded as a suspicious pair of “spurious correlation factor” with one of X and Y (Step S301).

The second partial correlation coefficient calculating unit 155 adds X and Y to the end of NodeList (Step S302). For example, the request types that are suspicious as the spurious correlation factor, X, and Y are stored in the NodeList.

Regarding all of the combinations of the pair of two request types in the NodeList, the second partial correlation coefficient calculating unit 155 copies each of the subject partial correlation coefficients to a work area (Step S303). The partial correlation coefficient copied in a work area is referred to as an interim correlation coefficient.

The second partial correlation coefficient calculating unit 155 loops the processes from Step S300a to Step S300b. If the number of request types in the NodeList is equal to or greater than two (Yes at Step S304), the second partial correlation coefficient calculating unit 155 proceeds to Step S305. If the number of request types in the NodeList is not equal to or greater than two (No at Step S304), the second partial correlation coefficient calculating unit 155 proceeds to Step S300d.

The second partial correlation coefficient calculating unit 155 extracts the request type at the top in the NodeList (Step S305). Here, as an example, it is assumed that the extracted request type is the request type A.

The second partial correlation coefficient calculating unit 155 loops the process from Step S300b to Step S300c regarding all of the pairs of request types in the NodeList. Here, it is assumed that the pair of the request type is a request type M and a request type N.

By using both the interim correlation coefficient between the request type A and the request type M and the interim correlation coefficient between the request type A and the request type N, the second partial correlation coefficient calculating unit 155 calculates the partial correlation coefficient between the request type M and the request type N that is obtained by removing the effect of the request type A from the interim correlation coefficient between the request type M and the request type N (Step S306).

The second partial correlation coefficient calculating unit 155 sets the obtained partial correlation coefficient to a new interim correlation coefficient between the request type M and the request type N (Step S307). The second partial correlation coefficient calculating unit 155 proceeds to Step S308 after performing the process at Step S300d.

The request type X and the request type Y remain in the NodeList. The second partial correlation coefficient calculating unit 155 sets the interim correlation coefficient of the request types X and Y at this point as the partial correlation coefficient (the second partial correlation coefficient) between X and Y that is obtained by comprehensively removing the spurious correlation generated due to the effect of the request types that has correlation with X or Y (Step S308).

In the following, the advantage of the delay information output device 100 according to the embodiment will be described. The delay information output device 100 calculates the correlation coefficient between the request types on the basis of the number of calls and the number of delays for each request. Then, the delay information output device 100 calculates the partial correlation coefficient by removing the effect of the overall trend and the reciprocal effect from the calculated correlation coefficient and determines, on the basis of the calculated partial correlation coefficient, the set of request types that have the call relationship. Consequently, it is possible to output information on the request that causes a delay. Furthermore, it is possible to narrow down the request types that cause a delay and reduce the time needed to investigate the cause.

For example, if both the time series data of the number of calls of the request type A and the request type of the number of delays of the request type B correlates the time series data of the total number of calls or the total number of delays of all of the request types, the correlation coefficient between the request types A and B becomes high. In order to remove the false correlation, by removing the effect of the overall trend from the correlation coefficient between each of the set of the request types, it is possible to restrain the set of the request types that does not cause a delay from being extracted.

For example, it is assumed that the time series data of the number of calls of the request type A has the correlation with the time series data of the number of calls of the request type B. In this case, the correlation coefficient may possibly be high between the time series data of the number of delays of the request type A and the time series data of the number of delays of the request type B even if no correlation is present at all between these request types. In order to remove this kind of false correlation, by comprehensively removing, using the partial correlation analysis, the reciprocal effect between the request types from the correlation coefficient (the first correlation coefficient), it is possible to restrain the set of request types that does not cause a delay from being extracted.

Furthermore, if the set of the request types that have the call relationship is on the basis of the partial correlation coefficient between the number of calls of the request type A and the number of delays of the request type B, the delay information output device 100 determines that the request type A is the cause of the delay. Consequently, it is possible to accurately determine the request type that causes the delay.

Furthermore, because the delay information output device 100 calculates the score for each request type that is suspected of a delay and ranks, on the basis of the scores, the request types that are suspected of the delay, it is possible to easily specify the request type that causes the delay.

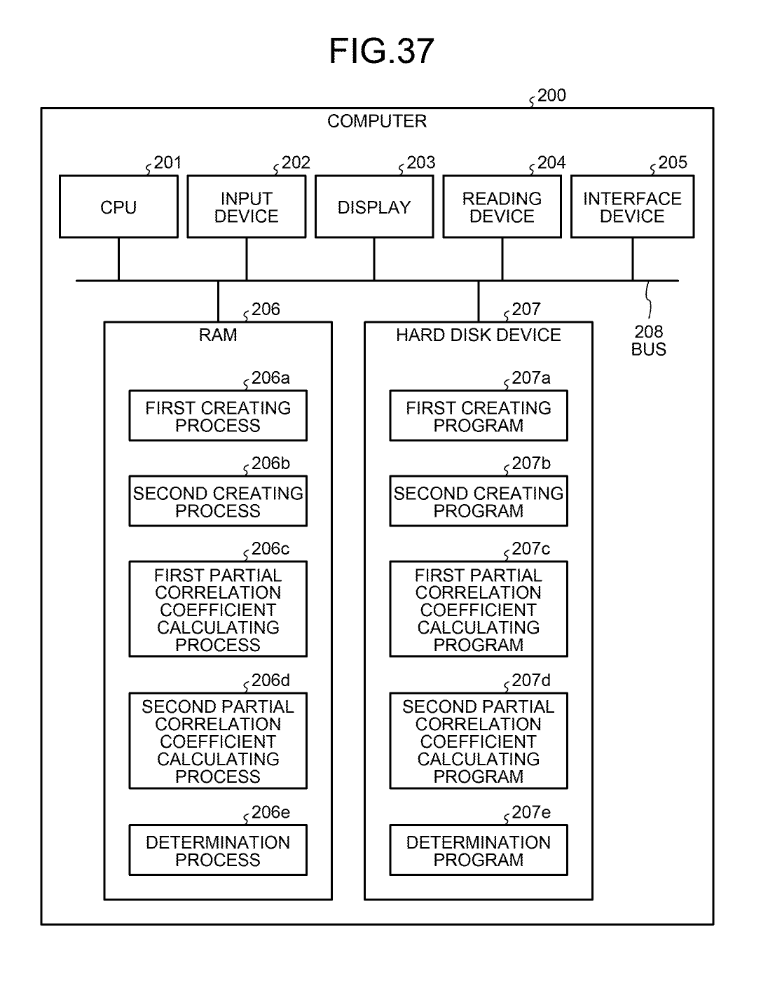

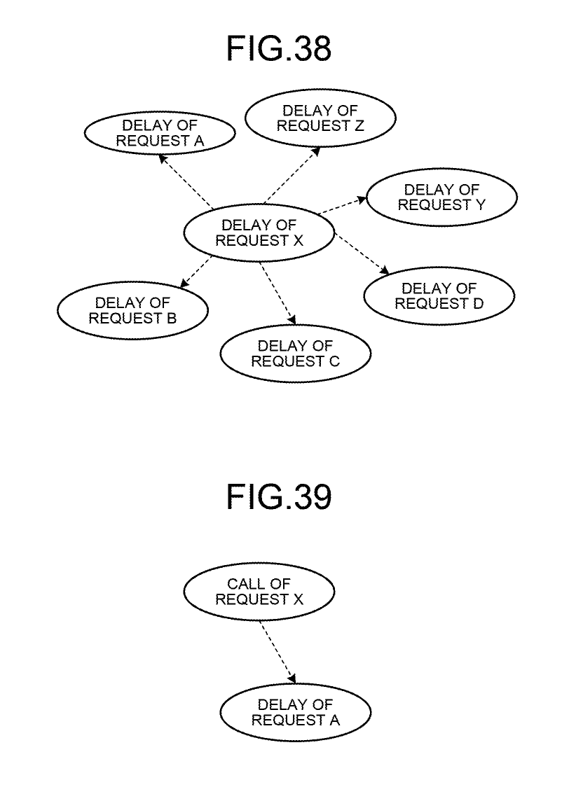

In the following, a description will be given of an example of a computer that executes a delay information output program and that implements the same function as that performed by the delay information output device 100 described in the above described embodiment. FIG. 37 is a block diagram illustrating an example of a computer that executes a delay information output program.

As illustrated in FIG. 37, a computer 200 includes a CPU 201 that executes various kinds of arithmetic processing, an input device 202 that receives an input of data from a user, and a display 203. Furthermore, the computer 200 includes a reading device 204 that reads a program or the like from a storage medium and an interface device 205 that sends and receives data to and from another computer via a network. Furthermore, the computer 200 includes a RAM 206 that temporarily stores therein various kinds of information and a hard disk device 207. Then, each of the devices 201 to 207 is connected to a bus 208.

The hard disk device 207 includes a first creating program 207a, a second creating program 207b, a first partial correlation coefficient calculating program 207c, a second partial correlation coefficient calculating program 207d, and a determination program 207e. The CPU 201 includes the first creating program 207a, the second creating program 207b, the first partial correlation coefficient calculating program 207c, the second partial correlation coefficient calculating program 207d, and the determination program 207e and loads the programs in the RAM 206.

The first creating program 207a functions as a first creating process 206a. The second creating program 207b functions as a second creating process 206b. The first partial correlation coefficient calculating program 207c functions as a first partial correlation coefficient calculating process 206c. The second partial correlation coefficient calculating program 207d functions as a second partial correlation coefficient calculating process 206d. The determination program 207e functions as a determination process 206e.

The process of the first creating process 206a corresponds to the process performed by the first creating unit 152. The process of the second creating process 206b corresponds to the process performed by the second creating unit 153. The process performed by the first partial correlation coefficient calculating process 206c corresponds to the process performed by the first partial correlation coefficient calculating unit 154. The process performed by the second partial correlation coefficient calculating process 206d corresponds to the process performed by the second partial correlation coefficient calculating unit 155. The process performed by the determination process 206e corresponds to the process performed by the determination unit 156.

Furthermore, the first creating program 207a, the second creating program 207b, the first partial correlation coefficient calculating program 207c, the second partial correlation coefficient calculating program 207d, and the determination program 207e do not need to be stored in the hard disk device 207 from the beginning. For example, the programs are stored in a “portable physical medium”, such as a flexible disk (FD), a CD-ROM, a DVD disk, a magneto-optic disk, an IC CARD, or the like that is to be inserted into the computer 200. Then, the computer 200 may read and execute the first creating program 207a, the second creating program 207b, the first partial correlation coefficient calculating program 207c, the second partial correlation coefficient calculating program 207d, and the determination program 207e from the portable physical medium.

It is possible to output information on a request that causes a delay.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A delay information output device comprising:
a processor that executes a process comprising:
calculating a first partial correlation coefficient by removing an effect of both the number of calls, per time, of all of requests and the number of delays, per time, of all of requests with a response time that exceeds an allowed time from a correlation coefficient between a first request and a second request on the basis of first information that indicates, per time, the number of calls of a request for each type between predetermined devices and on the basis of second information that indicates, per time, the number of delays of a request for each type with the response time that exceeds the allowed time that is allowed as the time needed for a response when the request is called;
calculating a second partial correlation coefficient by removing an effect of requests that are other than the first request and the second request from the first partial correlation coefficient; and
determining a set of requests that have the cause-and-effect relationship of a delay on the basis of the second partial correlation coefficient.

2. The delay information output device according to claim 1, the process further comprising:
analyzing a packet communicated between the predetermined devices;
creating the first information on the basis of a result of the analyzing; and
creating the second information on the basis of information in which the type of a request is associated with the allowed time and on the basis of the response time of each of the requests between the predetermined devices.

3. The delay information output device according to claim 1, wherein the correlation coefficient includes a correlation coefficient between the number of calls, per time, of the first request and the number of delays, per time, of the second request or includes a correlation coefficient between the number of delays, per time, of the first request and the number of delays, per time, of the second request.

4. The delay information output device according to claim 3, wherein, the determining determines that the first request is the cause of the delay of the second request when the determining determines that the set of the first request and the second request is a set of requests that have the cause-and-effect relationship of the delay from the second partial correlation coefficient between the number of calls, per time, of the first request and the number of delays, per time, of the second request.

5. The delay information output device according to claim 3, wherein the determining determines a priority order related to the cause of the delay between the first request and the second request on the basis of the score that is based on the second partial correlation coefficient between the first request and another request that has correlation with the first request and on the basis of the score that is based on the second partial correlation coefficient between the second request and another request that has correlation with the second request.

6. A delay information output method comprising:
calculating a first partial correlation coefficient by removing an effect of both the number of calls, per time, of all of requests and the number of delays, per time, of all of requests with a response time that exceeds an allowed time from a correlation coefficient between a first request and a second request on the basis of first information that indicates, per time, the number of calls of a request for each type between predetermined devices and on the basis of second information that indicates, per time, the number of delays of a request for each type with the response time that exceeds the allowed time that is allowed as the time needed for a response when the request is called, using a processor;
calculating a second partial correlation coefficient by removing an effect of requests that are other than the first request and the second request from the first partial correlation coefficient, using the processor; and
determining a set of requests that have the cause-and-effect relationship of a delay on the basis of the second partial correlation coefficient, using the processor.

7. The delay information output method according to claim 6, further comprising:
analyzing a packet communicated between the predetermined devices, using the processor;
creating the first information on the basis of a result of the analyzing, using the processor; and
creating the second information on the basis of information in which the type of a request is associated with the allowed time and on the basis of the response time of each of the requests between the predetermined devices, using the processor.

8. The delay information output method according to claim 6, wherein the correlation coefficient includes a correlation coefficient between the number of calls, per time, of the first request and the number of delays, per time, of the second request or includes a correlation coefficient between the number of delays, per time, of the first request and the number of delays, per time, of the second request.

9. The delay information output method according to claim 8, wherein the determining determines that the first request is the cause of the delay of the second request when the determining determines that the set of the first request and the second request is a set of requests that have the cause-and-effect relationship of the delay from the second partial correlation coefficient between the number of calls, per time, of the first request and the number of delays, per time, of the second request.

10. The delay information output method according to claim 8, wherein the determining determines a priority order related to the cause of the delay between the first request and the second request on the basis of the score that is based on the second partial correlation coefficient between the first request and another request that has correlation with the first request and on the basis of the score that is based on the second partial correlation coefficient between the second request and another request that has correlation with the second request.

11. A non-transitory computer-readable recording medium having stored therein a delay information output program that causes a computer to execute a process comprising:
calculating a first partial correlation coefficient by removing an effect of both the number of calls, per time, of all of requests and the number of delays, per time, of all of requests with a response time that exceeds an allowed time from a correlation coefficient between a first request and a second request on the basis of first information that indicates, per time, the number of calls of a request for each type between predetermined devices and on the basis of second information that indicates, per time, the number of delays of a request for each type with the response time that exceeds the allowed time that is allowed as the time needed for a response when the request is called;
calculating a second partial correlation coefficient by removing an effect of requests that are other than the first request and the second request from the first partial correlation coefficient; and
determining a set of requests that have the cause-and-effect relationship of a delay on the basis of the second partial correlation coefficient.

12. The non-transitory computer-readable recording medium according to claim 11, the process further comprising:
analyzing a packet communicated between the predetermined devices;
creating the first information on the basis of a result of the analyzing; and
creating the second information on the basis of information in which the type of a request is associated with the allowed time and on the basis of the response time of each of the requests between the predetermined devices.

13. The non-transitory computer-readable recording medium according to claim 11, wherein the correlation coefficient includes a correlation coefficient between the number of calls, per time, of the first request and the number of delays, per time, of the second request or includes a correlation coefficient between the number of delays, per time, of the first request and the number of delays, per time, of the second request.

14. The non-transitory computer-readable recording medium according to claim 13, wherein the determining determines that the first request is the cause of the delay of the second request when the determining determines that the set of the first request and the second request is a set of requests that have the cause-and-effect relationship of the delay from the second partial correlation coefficient between the number of calls, per time, of the first request and the number of delays, per time, of the second request.

15. The delay information output program according to claim 13, wherein the determining determines a priority order related to the cause of the delay between the first request and the second request on the basis of the score that is based on the second partial correlation coefficient between the first request and another request that has correlation with the first request and on the basis of the score that is based on the second partial correlation coefficient between the second request and another request that has correlation with the second request.
